(19) United States
(12) Patent Application Publication
(10) Pub. No.: US 2023/0413812 A1
(43) Pub. Date: Dec. 28, 2023

(54) SANITIZING COMPOSITIONS CONTAINING IONIC LIQUID

(71) Applicant: CAGE BIO, INC., San Carlos, CA (US)

(72) Inventors: Nitin JOSHI, Redwood City, CA (US); Marina SHEVACHMAN, Los Gatos, CA (US); Kevin W. GELSTON, San Francisco, CA (US); Abhirup MANDAL, Fort Worth, TX (US)

(21) Appl. No.: 18/037,314

(22) PCT Filed: Nov. 17, 2021
(86) PCT No.: PCT/US2021/059777

§ 371 Date: May 16, 2023

Related U.S. Application Data
(60) Provisional application No. 63/114,837, filed on Nov. 17, 2020.

(51) Int. Cl. A01N 33/12; A01N 31/02; A01N 25/30; A01P 1/00

(52) U.S. Cl. CPC A01N 33/12; A01N 31/02; A01N 25/30; A01P 1/00

(57) ABSTRACT

Disclosed herein are sanitizing/disinfecting compositions comprising an ionic liquid comprising a choline cation and fatty acid anion for use in sanitizing or disinfecting surfaces. In some embodiments, the ionic liquid is further formulated as a surface disinfectant for inanimate surfaces.

### BACKGROUND

The use of sanitizing products continues to grow, both within the United States and internationally. Sanitizers can be found in hospitals and other healthcare environments, the workplace, and in everyday home use. These products are considered especially useful when microbial contamination is a concern, particular in high risk areas of hospitals and prior to surgical procedures.

### SUMMARY OF THE DISCLOSURE

In an aspect, provided herein is a disinfectant composition for an inanimate surface, comprising:
an ionic liquid having a cationic component and an anionic component;
wherein the composition comprises about 1% to about 10% by weight of the ionic liquid.

In an aspect provided herein, there is a kit comprising a disinfectant composition for an inanimate surface, comprising:
an ionic liquid having a cationic component and an anionic component;
wherein the composition comprises about 1% to about 10% by weight of the ionic liquid; and a dispenser or applicator.

A wipe, comprising a surface retaining a releasable disinfectant composition for an inanimate surface, comprising:
an ionic liquid having a cationic component and an anionic component;
wherein the composition comprises about 1% to about 10% by weight of the ionic liquid. In some embodiments, the surface retaining a releasable disinfectant composition is a textile. In some embodiments, the textile is cloth, a wipe, a sponge, or a mop.

In an aspect provided herein, is a method of sanitizing or disinfecting a surface, comprising applying to the surface a disinfectant composition for an inanimate surface, comprising:
an ionic liquid having a cationic component and an anionic component;
wherein the composition comprises about 1% to about 10% by weight of the ionic liquid.

In an aspect provided herein, is a method of sanitizing or disinfecting a surface, comprising applying to the surface a wipe, comprising a surface retaining a releasable disinfectant composition for an inanimate surface, comprising:
an ionic liquid having a cationic component and an anionic component;
wherein the composition comprises about 1% to about 10% by weight of the ionic liquid.

In an aspect provided herein, is a method for inhibiting or decreasing microbial growth on a surface, comprising: applying to the surface a wipe, comprising a surface retaining a releasable disinfectant composition for an inanimate surface, comprising:
an ionic liquid having a cationic component and an anionic component;
wherein the composition comprises about 1% to about 10% by weight of the ionic liquid.

In an aspect provided herein, is a method for inhibiting or decreasing microbial growth on a surface, comprising applying to the surface a wipe, comprising a surface retaining a releasable disinfectant composition for an inanimate surface, comprising:
an ionic liquid having a cationic component and an anionic component;
wherein the composition comprises about 1% to about 10% by weight of the ionic liquid.

In some embodiments, the ionic liquid is a deep eutectant solvent. In some embodiments, the composition is non-irritating to skin, and

[symbol]

In some embodiments, at least one of the anionic component and cationic component is irritating to the skin when applied in the absence of the other component.

In some embodiments, the anionic component is bistriflimide, a geranate, an oleate, a hexanoate, dodecyldimethyl ammonia propane sulfonate, N-lauryl sarcosinate, or a geraniolate.

In some embodiments, the cationic component is benzyl pyridinium, benzyl dimethyl dodecyl ammonium, a choline cation, phosphonium, benzethonium, or a phosphonium.

In some embodiments, the phosphonium is a tetraalkyl phosphonium of structural Formula PR₄, wherein R is a substituted or unsubstituted alkyl group.

In some embodiments, the cationic component is a choline cation.

In some embodiments, the anionic component is a geranate anion

In some embodiments, the cationic component and the anionic component are in a molar ratio ranging from about 1:1 to about 1:4 (cationic component to anionic component).

In some embodiments, the cationic component and the anionic component are in a molar ratio ranging from about 1:1 to about 1:2 (cationic component to anionic component).

In some embodiments, the cationic component and the anionic component are in a molar ratio of about 1:2 (cationic component to anionic component).

In some embodiments, the composition comprises about 1% to about 5% by weight of the ionic liquid.

In some embodiments, the composition comprises about 1% to about 3% by weight of the ionic liquid.

In some embodiments, the composition further comprises at least one additive or carrier.

In some embodiments, the composition further comprises a pH adjuster, skin conditioner, colorants, fragrance, viscosity enhancing agent, humectant, emollient, antioxidant, preservative, solvent, co-solvent, surfactant, chelant, solubilizer, coupling agent, corrosion inhibitor, rheology modifier, UV stabilizer, optical brightener, active ingredient indicators, or combinations thereof.

In some embodiments, the fragrance is D-limonene.

In some embodiments, the fragrance is present in the composition an amount of from about 0.2% to about 1.0% by weight.

In some embodiments, the fragrance is present in the composition an amount of from about 0.4% to about 0.6% by weight.

In some embodiments, the fragrance is present in the composition an amount of about 0.6% by weight.

In some embodiments, the surfactant is a poloxamer, such as Poloxamer 407.

In some embodiments, the humectant is present in the composition an amount of from about 2% to about 10% by weight. In some embodiments, the humectant is present in the composition an amount of from about 3% to about 10% by weight. In some embodiments, the humectant is present in the composition an amount of from about 4% to about 10% by weight. In some embodiments, the humectant is present in the composition an amount of from about 5% to about 10% by weight.

In some embodiments, the composition further comprises emollients.

In some embodiments, the composition further comprises hydroxypropyl cellulose, hydroxypropyl methyl cellulose, methyl cellulose, ethylene glycol monopropyl ether, ethylene glycol monobutyl ether, ethylene glycol monohexyl ether, ethylene clycol monohexyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, propylene glycol methyl ether, propylene glycol methyl ether acetate, propylene glycol n-butyl ether, dipropylene glycol n-butyl ether, dipropylene glycol methyl ether, dipropylene glycol methyl ether acetate, propylene glycol n-propyl ether, dipropylene glycol n-propyl ether, and tripropylene glycol methyl ether.

In some embodiments, the viscosity enhancing agent is hydroxypropyl cellulose.

In some embodiments, the viscosity enhancing agent is present in the composition in an amount of from about 0.005% to about 0.4% by weight.

In some embodiments, the viscosity enhancing agent is present in the composition in an amount of from about 0.005% to about 0.02% by weight.

In some embodiments, the hydroxypropyl cellulose is present in the composition an amount of from about 0.005% to about 0.400% by weight.

In some embodiments, the hydroxypropyl cellulose is present in the composition an amount of about 0.01% by weight.

In some embodiments, the pH adjustor is triethanolamine, diethanolamine, monoethanolamine, sodium hydroxide, sodium carbonate, potassium hydroxide, potassium carbonate, calcium carbonate, citric acid, acetic acid, hydrochloric acid, sulfamic acid, sulfuric acid, or combinations thereof.

In some embodiments, the composition has a pH of from about 6.0 to about 8.0.

In some embodiments, the composition further comprises water.

In some embodiments, the composition further comprises a C₁-C₈ alcohol. In some embodiments, the alcohol is ethanol, iso-propyl alcohol, n-propyl alcohol, butanol, pentanol, or combinations thereof. In some embodiments, the alcohol is ethanol, iso-propyl alcohol, or a combination thereof. In some embodiments, the alcohol is ethanol. In some embodiments, the alcohol is present in the composition in an amount of from about 45% to about 70% by weight. In some embodiments, the ethanol is present in the composition in an amount of about 50% to about 70% by weight. In some embodiments, the ethanol is present in the composition in an amount of about 60% by weight. In some embodiments, the alcohol is iso-propyl alcohol. In some embodiments, the iso-propyl alcohol is present in the composition in an amount of from about 1% to about 10% by weight. In some embodiments, the iso-propyl alcohol is present in the composition in an amount of about 4% to about 8% by weight. In some embodiments, the iso-propyl alcohol is present in the composition in an amount of about 4% to about 6% by weight. In some embodiments, the iso-propyl alcohol is present in the composition in an amount of about 5% by weight. In some embodiments, the alcohol is a mixture of ethanol and iso-propyl alcohol.

In some embodiments, the composition is placed on or in an applicator or dispenser. In some embodiments, the applicator or dispenser is a cloth, a wipe, a sponge, a mop, a squirt bottle, a spray bottle, a pump bottle, a tube, an automatic induction hand sterilizer, a bottle or container comprising a dropper, bottle or container comprising a pour spout, or a canister. In some embodiments, the spray bottle is a continuous spray bottle, a propellant-free continuous spray bottle, a flairosol sprayer, an aerosol sprayer, or a mist spray bottle.

In some embodiments, the composition is formulated for administration to a surface. In some embodiments, the composition is formulated for application to a hard surface. In some embodiments, the composition is formulated for application to a non-porous surface. In some embodiments, the composition is formulated for application to a porous surface.

In some embodiments, the composition is rinseless.

In some embodiments, the composition further comprises a sporicide and/or additional antimicrobial agent. In some embodiments, the sporicide is hydrogen peroxide.

In some embodiments, the composition is formulated to remain on a surface for at least about two hours. In some embodiments, the composition is formulated to remain on a surface for at least about four hours. In some embodiments, the composition is formulated to remain on a surface for at least up to about 24 hours. In some embodiments, the composition is formulated to remain on a surface until rinsed or washed off. In some embodiments, the composition is rinseless.

In some embodiments, the microbial growth is growth of a virus, bacterium, fungus, mold, protozoan, parasite, or combinations thereof. In some embodiments, the bacterium is a gram-negative bacterium. In some embodiments, the gram-negative bacterium is an Escherichia, Salmonella, Klebsiella bacterium, or any combination thereof. In some embodiments, the Escherichia bacterium is E. coli. In some embodiments, the bacterium is a gram-positive bacterium.

In some embodiments, the gram-positive bacterium is a Staphylococcus or Streptococcus bacterium. In some embodiments, the Staphylococcus bacterium is methicillin-resistant S. aureus (MRSA). In some embodiments, the virus is an Ebolavirus, Coronavirus, Rotavirus, Alphainfluenzavirus, Betainfluenzavirus, Deltainfluenzavirus, Gammainfluenzavirus, or any combination thereof. In some embodiments, the virus is a Coronavirus. In some embodiments, the Coronavirus is severe acute respiratory syndrome coronavirus 2 (SARS-CoV-2). In some embodiments, the virus is a human virus.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows the results of self-sanitizing activity study of disinfectant of the present disclosure with a cleaned glass surface as a control.

FIG. 2 shows the results of self-sanitizing activity study of disinfectant of the present disclosure with negative sterile saline solution) and positive (Microban® 24) controls at varying concentrations of CGB-D-100, six (6) wearing cycles and five (5) re-inoculations. S1 is Sample 1 and S2 is Sample 2.

FIG. 3 shows the results of self-sanitizing activity study of disinfectant of the present disclosure with negative sterile saline solution) and positive (Microban® 24) controls at varying concentrations of CGB-D-100.

FIG. 4 shows the results of residual self-sanitizing activity study of CG-101 formulations and comparison to the marketed product Microban® 24.

FIG. 5 shows Neutralization Confirmation of Positive Control (PC) and 5% CG-101 Disinfectant Comparatively to the Negative Control (NC). The bacterial growth obtained on the plates where suspension with Microban® 24 and 5% CG-101 disinfectant was plated is similar to that obtained for the saline solution samples.

FIGS. 6A-6B show the results of an antimicrobial efficacy study based on 1%, 3%, and 5% CG-101 in water.

FIGS. 7A-7E show the results of a self-sanitizing activity study based on 5% CG-101 in water, in 5% aqueous Poloxamer 40, and in 10% aqueous Poloxamer 407.

### DETAILED DESCRIPTION OF THE DISCLOSURE

Alcohol and alcohol gels in which alcohol levels exceed about 50% have the most pronounced immediate antimicrobial effects; however, they lack persistent antimicrobial properties, i.e., residual activity or effect. Although alcohol may kill microbes on contact, upon drying, there is no means for killing or controlling microbial growth. As such, sanitizers using alcohol alone are often less effective over time. There is a need, therefore, for hand sanitizers having enhanced and prolonged antimicrobial activity and excellent residual activity.

### I. Definitions

The terminology used herein is for the purpose of describing particular cases only and is not intended to be limiting. The below terms are discussed to illustrate meanings of the terms as used in this specification, in addition to the understanding of these terms by those of skill in the art. As used herein and in the appended claims, the singular forms “a,” “an,” and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number. Where a range of values is provided, it is understood that each intervening value, to the tenth of the unit of the lower limit unless the context clearly dictates otherwise, between the upper and lower limit of that range and any other stated or intervening value in that stated range, is encompassed within the methods and compositions described herein are. The upper and lower limits of these smaller ranges may independently be included in the smaller ranges and are also encompassed within the methods and compositions described herein, subject to any specifically excluded limit in the stated range. Where the stated range includes one or both of the limits, ranges excluding either or both of those included limits are also included in the methods and compositions described herein.

The terms “individual,” “patient,” or “subject” are used interchangeably. None of the terms require or are limited to situation characterized by the supervision (e.g., constant or intermittent) of a health care worker (e.g. a doctor, a registered nurse, a nurse practitioner, a physician's assistant, an orderly, or a hospice worker). Further, these terms refer to human or animal subjects.

“Treating” or “treatment” refers to both therapeutic treatment and prophylactic or preventative measures, wherein the object is to prevent or slow down (lessen) a targeted pathologic condition or disorder.

The term “antimicrobial agent” is an agent that kills microorganisms, stops or slows their growth, or prevents their growth. Antimicrobial agents diminish the number of microbes on a surface. Examples of antimicrobial agents include, but are not limited to, disinfectants, antiseptics, antiviral agents, and antibiotics.

“Microbes” or “microorganisms,” as referred to herein, are synonymous and used interchangeably. A microorganism, or microbe, is a microscopic organism, which may exist in its single-celled form or in a colony of cells. Microorganisms include all unicellular organisms. Microbes include, but are not limited to, viruses, archaea, bacteria, and eukaryotes such as protists (e.g., algae species), and fungi.

The terms “bacteria,” “bacterium,” and “bacterial growth” are used interchangeably to mean

The percentages given herein refer to the percentage by weight of the specified component in a mixture, i.e. “weight percent.” The terms “weight percent,” “% by weight,” “% w/w,” and “wt. %” are synonymous and used interchangeably herein.

The terms “effective amount” or “therapeutically effective amount,” as used herein, refer to a sufficient amount of an agent or a compound being administered which will relieve to some extent one or more of the symptoms of the disease or condition being treated. The result can be reduction and/or alleviation of the signs, symptoms, or causes of a disease, or any other desired alteration of a biological system. For example, an “effective amount” for therapeutic uses is the amount of the composition including a compound as disclosed herein required to provide a clinically significant decrease in disease symptoms without undue adverse side effects. An “effective amount” for non-therapeutic uses (e.g., a sanitizer/disinfectant for an inanimate surface) is the amount of the composition including a compound as disclosed herein required to provide a clinically significant decrease in microbial growth or microbial inhibition. An appropriate “effective amount” in any individual case may be determined using techniques, such as a dose escalation study. The term “therapeutically effective amount” includes, for example, a prophylactically effective amount. An “effective amount” of a compound disclosed herein is an amount effective to achieve a desired pharmacologic effect or therapeutic improvement without undue adverse side effects. It is understood that “an effect amount” or “a therapeutically effective amount” can vary from subject to subject, due to variation in metabolism of the compound, age, weight, general condition of the subject, the condition being treated, the severity of the condition being treated, and the judgment of the prescribing physician. By way of example only, therapeutically effective amounts may be determined by routine experimentation, including but not limited to a dose escalation clinical trial.

### II. Sanitizing Ionic Liquid Compositions

Described herein, in certain embodiments, are compositions comprising an ionic liquid comprising a choline cation and a fatty acid anion. In some embodiments, the composition further comprises an acceptable solvent. In some embodiments, the solvent is a pharmaceutically acceptable solvent. In some embodiments, the fatty acid is myristoleic acid, palmitoleic acid, sapienic acid, oleic acid, elaidic acid, geranic acid, vaccenic acid, linoleic acid, linoelaidic acid, α-linolenic acid, arachidonic acid, eicosapentaenoic acid, erucic acid, docosahexaenoic acid, propionic acid, butyric acid, valeric acid, hexanoic acid, enanthic acid, caprylic acid, pelargonic acid, capric acid, undecylic acid, lauric acid, tridecyclic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, henatriacontylic acid, lacceroic acid, psyllic acid, geddic acid, ceroplastic acid, or hexatriacontylic acid. In some embodiments, the fatty acid is geranic acid. In some embodiments, the fatty acid comprises 9 to 14 carbons. In some embodiments, the ionic liquid is liquid at room temperature. In some embodiments, the ionic liquid is liquid below 100° C.

In an aspect, provided herein is a sanitizing composition for an inanimate surface, comprising: an ionic liquid having a cationic component and an anionic component;
wherein the composition comprises about 1% to about 10% by weight of the ionic liquid.

In some embodiments, the ionic liquid is a deep eutectant solvent. In some embodiments, the ionic liquid is non-irritating to the skin.

In some embodiments, at least one of the anionic component and cationic component is irritating to the skin when applied in the absence of the other component.

In some embodiments, the anionic component is bistriflimide, a geranate, an oleate, a hexanoate, dodecyldimethyl ammonia propane sulfonate, N-lauryl sarcosinate, or a geraniolate.

In some embodiments, the cationic component is benzyl pyridinium, benzyl dimethyl dodecyl ammonium, a choline cation, phosphonium, benzethonium, or a phosphonium.

In some embodiments, the phosphonium is a tetraalkyl phosphonium of structural Formula (I): PR₄, wherein R is a substituted or unsubstituted alkyl group.

In some embodiments, the cationic component is a choline cation.

In some embodiments, the anionic component is a geranate anion

In some embodiments, the cationic component and the anionic component are in a molar ratio ranging from about 1:1 to about 1:2 (cationic component to anionic component).

In some embodiments, the cationic component and the anionic component are in a molar ratio of about 1:2 (cationic component to anionic component).

In some embodiments, the composition comprises about 1% to about 5% by weight of the ionic liquid.

In some embodiments, the composition comprises about 1% to about 3% by weight of the ionic liquid.

In some embodiments, the composition further comprises at least one additive or carrier.

In some embodiments, the composition further comprises a pH adjuster, skin conditioner, colorants, fragrance, viscosity enhancing agent, humectant, emollient, antioxidant, preservative, solvent, co-solvent, chelant, solubilizer, coupling agent, corrosion inhibitor, rheology modifier, UV stabilizer, optical brightener, active ingredient indicators, or combinations thereof.

In some embodiments, the fragrance is D-limonene.

In some embodiments, the fragrance is present in the composition an amount of from about 0.2% to about 1.0% by weight.

In some embodiments, the fragrance is present in the composition an amount of from about 0.4% to about 0.6% by weight.

In some embodiments, the fragrance is present in the composition an amount of about 0.6% by weight.

In some embodiments, the viscosity enhancing agent is hydroxypropyl cellulose.

In some embodiments, the viscosity enhancing agent is present in the composition in an amount of from about 0.005% to about 0.4% by weight.

In some embodiments, the viscosity enhancing agent is present in the composition in an amount of from about 0.005% to about 0.02% by weight.

In some embodiments, the viscosity enhancing agent is present in the composition in an amount of about 0.1% by weight.

In some embodiments, the viscosity enhancing agent is present in the composition in an amount of about 0.5% by weight.

In some embodiments, the humectant is glycerin.

In some embodiments, the humectant is present in the composition an amount of from about 0.5% to about 5% by weight.

In some embodiments, the humectant is present in the composition an amount of from about 1% to about 2% by weight.

In some embodiments, the solvent is a terpene alcohol, terpene ester, terpene ether, terpene aldehyde, or combinations thereof.

In some embodiments, the solvent is pine oil, lemon oil, limonene, pinene, cymene, myrcene, fenchone, borneol, nopol, cineole, ionone, or combinations thereof.

In some embodiments, the composition further comprises emollients.

In some embodiments, the composition further comprises hydroxypropyl cellulose, hydroxypropyl methyl cellulose, methyl cellulose, ethylene glycol monopropyl ether, ethylene glycol monobutyl ether, ethylene glycol monohexyl ether, ethylene clycol monohexyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, propylene glycol methyl ether, propylene glycol methyl ether acetate, propylene glycol n-butyl ether, dipropylene glycol n-butyl ether, dipropylene glycol methyl ether, dipropylene glycol methyl ether acetate, propylene glycol n-propyl ether, dipropylene glycol n-propyl ether, and tripropylene glycol methyl ether.

In some embodiments, the hydroxypropyl cellulose is present in the composition an amount of from about 0.005% to about 0.400% by weight. In some embodiments, the hydroxypropyl cellulose is present in the composition an amount of about 0.01% by weight. In some embodiments, the hydroxypropyl cellulose is present in the composition an amount of at least about 0.005%. In some embodiments, the hydroxypropyl cellulose is present in the composition an amount of up to about 0.400% by weight. In some embodiments, the hydroxypropyl cellulose is present in the composition an amount of about 0.005, about 0.006, about 0.007, about 0.008, about 0.009, about 0.01, about 0.02, about 0.03, about 0.04, about 0.05, about 0.06, 0.07, about 0.08, about 0.09, about 0.1, about 0.2, about 0.3, about 0.4, or about 0.5% by weight.

In some embodiments, the pH adjustor is triethanolamine, diethanolamine, monoethanolamine, sodium hydroxide, sodium carbonate, potassium hydroxide, potassium carbonate, calcium carbonate, citric acid, acetic acid, hydrochloric acid, sulfamic acid, sulfuric acid, or combinations thereof.

In some embodiments, the composition has a pH of from about 6.0 to about 8.0.

In some embodiments, the composition further comprises water.

In some embodiments, the composition further comprises a Ci-C8 alcohol. In some embodiments, the alcohol is ethanol, iso-propyl alcohol, n-propyl alcohol, butanol, pentanol, or combinations thereof. In some embodiments, the alcohol is ethanol, iso-propyl alcohol, or a combination thereof. In some embodiments, the alcohol is ethanol. In some embodiments, the alcohol is present in the composition in an amount of from about 45% to about 70% by weight. In some embodiments, the ethanol is present in the composition in an amount of about 50% to about 70% by weight. In some embodiments, the ethanol is present in the composition in an amount of about 60% by weight. In some embodiments, the ethanol is present in the composition in an amount of at least about 45% by weight. In some embodiments, the ethanol is present in the composition in an amount of up to about 70% by weight. In some embodiments, the ethanol is present in the composition in an amount of about 45, about 50, about 55, about 60, about 65, about 70% by weight.

In some embodiments, the alcohol is iso-propyl alcohol. In some embodiments, the iso-propyl alcohol is present in the composition in an amount of from about 1% to about 10% by weight. In some embodiments, the iso-propyl alcohol is present in the composition in an amount of up to about 10% by weight. In some embodiments, the iso-propyl alcohol is present in the composition in an amount of at least about 10% by weight. In some embodiments, the iso-propyl alcohol is present in the composition in an amount of about 4% to about 6% by weight. In some embodiments, the iso-propyl alcohol is present in the composition in an amount of about 1, about 2, abut 3, about 4, about 5, about 6, about 7, about 8, about 9, or about 10% by weight. In some embodiments, the iso-propyl alcohol is present in the composition in an amount of about 5% by weight. In some embodiments, the alcohol is a mixture of ethanol and iso-propyl alcohol.

In some embodiments, the composition is formulated for administration to a surface. In some embodiments, the composition is formulated for application to a hard surface. In some embodiments, the composition is formulated for application to a non-porous surface. In some embodiments, the composition is formulated for application to a porous surface.

In some embodiments, the composition further comprises propylene glycol. In some embodiments, the composition further comprises about 1% to about 3% by weight propylene glycol.

In some embodiments, the composition further comprises about 1%, about 1.5%, about 2.0%, about 2.5%, or to about 3% by weight propylene glycol.

In some embodiments, the composition further comprises a sporicide and/or additional antimicrobial agent. In some embodiments, the sporicide is hydrogen peroxide.

In some embodiments, the composition is formulated to remain on a surface for at least about two hours. In some embodiments, the composition is formulated to remain on a surface for at least about four hours. In some embodiments, the composition is formulated to remain on a surface for at least up to about 24 hours. In some embodiments, the composition is formulated to remain on a surface until rinsed or washed off. In some embodiments, the composition is rinseless.

In some embodiments, the ionic liquid is a deep eutectic solvent (DES). In some embodiments, a DES comprises excess carboxylate which precludes 1:1 ion pairing. In some embodiments, a DES further comprises a hydrogen-bond donor. In some embodiments, the hydrogen-bond donor is urea or citric acid. In some embodiments, the solvent properties of a DES are adjusted by changing the hydrogen-bond donor. In some embodiments, the ammonium salt of a DES interacts with a hydrogen-bond donor. In some embodiments, the DES has a melting point lower than either of the individual components (e.g., fatty acid and choline).

In some embodiments, the ionic liquid comprises a molar ratio of a choline cation to a fatty acid anion of 1:0.5 to 1:10. In some embodiments, the molar ratio of the choline cation to the fatty acid anion is about 1:0.5, 1:0.6, 1:0.7, 1:0.8, 1:0.9, 1:1.0; 1:1.1, 1:1.2, 1:1.3, 1:1.4, 1:1.5, 1:1.6, 1:1.7, 1:1.8, 1:1.9, 1:2.0, 1:2.1, 1:2.2, 1:2.3, 1:2.4, 1:2.5, 1:2.6, 1:2.7, 1:2.8, 1:2.9, 1:3.0, 1:3.1, 1:3.2, 1:3.3, 1:3.4, 1:3.5, 1:3.6, 1:3.7, 1:3.8, 1:3.9, 1:4.0, 1:4.1, 1:4.2, 1:4.3, 1:4.4, 1:4.5, 1:4.6, 1:4.7, 1:4.8, 1:4.9. 1:5.0, 1:5.1, 1:5.2, 1:5.3, 1:5.4, 1:5.5, 1:5.6, 1:5.7, 1:5.8, 1:5.9, 1:6.0, 1:6.1, 1:6.2, 1:6.3, 1:6.4, 1:6.5, 1:6.6, 1:6.7, 1:6.8, 1:6.9, 1:7.0, 1:7.1, 1:7.2, 1:7.3, 1:7.4, 1:7.5, 1:7.6, 1:7.7, 1:7.8, 1:7.9, 1:8.0, 1:8.1, 1:8.2, 1:8.3, 1:8.4, 1:8.5, 1:8.6, 1:8.7, 1:8.8, 1:8.9, 1:9.0, 1:9.1, 1:9.2, 1:9.3, 1:9.4, 1:9.5, 1:9.6, 1:9.7, 1:9.8, 1:9.9, or about 1:10. In some embodiments, the molar ratio of the choline cation to the fatty acid anion is about 1:1.1, 1:1.2, 1:1.3, 1:1.4, 1:1.5, 1:1.6, 1:1.7, 1:1.8, 1:1.9, or 1:2.0.

In some embodiments, the choline cation and fatty acid anion are in a molar ratio in the ionic liquid. In some embodiments, the choline cation and fatty acid anion are in a molar ratio of 1:1. In some embodiments, the term Composition B is used herein to refer to a composition or an ionic liquid comprising a 1:1 molar ratio of choline cation to geranic acid anion. In some embodiments, Composition B does not comprise water.

In other embodiments, the choline cation and fatty acid anion are in a molar ratio of 1:2. In some embodiments, the term Composition A is used herein to refer to a composition or an ionic liquid comprising a 1:2 molar ratio of choline cation to geranic acid anion. In some embodiments, Composition A does not comprise water.

In some embodiments, the chemical structure of choline is:

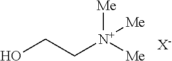

wherein X⁻ is a pharmaceutically acceptable anion.

In some embodiments, term choline refers to the class of quaternary ammonium salts containing the N,N,N-trimethylethanolammonium cation. In some embodiments, the X⁻ on the right of the structure of choline denotes a pharmaceutically acceptable anion. In some embodiments the X⁻ is bicarbonate, carbonate, acetate, citrate, tartarate, bitartarate, lactate, chloride, bromide, or iodide. In some embodiments, the X⁻ is bicarbonate. In some embodiments, the choline is an anti-inflammatory agent.

In some embodiments, choline is in the form of a pharmaceutically acceptable salt. The type of pharmaceutical acceptable salts, include, but are not limited to acid addition salts, formed by reacting the free base form of the compound with a pharmaceutically acceptable: inorganic acid such as hydrochloric acid, hydrobromic acid, sulfuric acid, nitric acid, phosphoric acid, metaphosphoric acid, and the like; or with an organic acid such as acetic acid, propionic acid, hexanoic acid, cyclopentanepropionic acid, glycolic acid, pyruvic acid, lactic acid, malonic acid, succinic acid, malic acid, maleic acid, fumaric acid, trifluoroacetic acid, tartaric acid, citric acid, benzoic acid, 3-(4-hydroxybenzoyl)benzoic acid, cinnamic acid, mandelic acid, methanesulfonic acid, ethanesulfonic acid, 1,2-ethanedisulfonic acid, 2-hydroxyethanesulfonic acid, benzenesulfonic acid, toluenesulfonic acid, 2-naphthalenesulfonic acid, 4-methylbicyclo-[2.2.2]oct-2-ene-1-carboxylic acid, glucoheptonic acid, 4,4′-methylenebis-(3-hydroxy-2-ene-1-carboxylic acid), 3-phenylpropionic acid, trimethylacetic acid, tertiary butylacetic acid, lauryl sulfuric acid, gluconic acid, glutamic acid, hydroxynaphthoic acid, salicylic acid, stearic acid, muconic acid, and the like.

In some embodiments, the chemical structure of geranic acid, or 3,7-dimethyl-2,6-octadienoic acid, is:

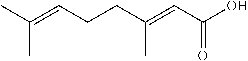

In some embodiments, geranic acid is in the form of a pharmaceutically acceptable salt. The type of pharmaceutical acceptable salts, include, but are not limited to salts formed when an acidic proton present in the parent compound either is replaced by a metal ion, e.g., an alkali metal ion (e.g. lithium, sodium, potassium), an alkaline earth ion (e.g., magnesium, or calcium), or an aluminum ion; or coordinates with an organic base. Examples of acceptable organic bases include, but are not limited to, ethanolamine, diethanolamine, triethanolamine, tromethamine, and N-methylglucamine. Examples of acceptable inorganic bases include, but are not limited to, aluminum hydroxide, calcium hydroxide, potassium hydroxide, sodium carbonate, and sodium hydroxide.

In some embodiments, the choline and the fatty acid are synthesized using any suitable standard synthetic reactions. In some embodiments, the reactions are employed in a linear sequence to provide the compounds or they may be used to synthesize fragments which are subsequently joined by any suitable method. In some embodiments, the starting material used for the synthesis of choline or fatty acid is synthesized or are obtained from commercial sources.

In some embodiments, geranic acid is purified from the commercially available technical grade (Sigma-Aldrich, St. Louis, Mo.) by repeated (5-7×) recrystallization from a solution of 70 wt % geranic acid/30 wt % acetone at −70° C. In some embodiments, purity of the geranic acid is assessed by ¹H NMR spectroscopy and conductivity measurements. In some embodiments, the term geranic acid refers to a geranic acid or a salt thereof. In some embodiments, the geranic acid is an anti-microbial agent.

In some embodiments, the compositions disclosed herein further comprise a pharmaceutically acceptable solvent is water, ethanol, diisopropyl adipate, polyethylene glycol (PEG), glycerin, propylene glycol, a short chain fatty acid, a fatty acid ester, or a combination thereof. In some embodiments, the pharmaceutically acceptable solvent is a liquid alcohol, liquid glycol, liquid polyalkalene glycol, liquid ester, liquid amine, liquid protein hydrolysate, liquid alkalated protein hydrolysate, liquid lanolin, lanolin derivative, water, or combinations thereof. In some embodiments, the pharmaceutically acceptable solvent is diisopropyl adipate. In some embodiments, the composition is miscible with the pharmaceutically acceptable solvent. In some embodiments, at least one of the individual components of the composition is not miscible with pharmaceutically acceptable solvent. In some embodiments, the composition is miscible with diisopropyl adipate. In some embodiments, at least one of the individual components of the composition is not miscible with diisopropyul adipate. In some embodiments, the water is deionized water or Milli-Q® water. In some embodiments, the composition does not comprise a preservative. Examples of preservatives include, but are not limited to, a paraben or a phenoxyethanol.

In some embodiments, the composition comprises an increased antimicrobial action compared to an antimicrobial action of choline or an antimicrobial action of the fatty acid. In some embodiments, the increased antimicrobial action is a 10 fold less concentration of the composition required for complete killing of a microbe relative to a concentration of choline or a concentration of the fatty acid required for complete killing of the microbe.

In some embodiments, the composition has decreased skin irritation relative to a skin irritation of choline or a skin irritation of the fatty acid. In some embodiments, the composition exhibits minimal cytotoxicity relative to a cytotoxicity of choline or a cytotoxicity of the fatty acid. In some embodiments, the composition comprises an increased conductivity relative to a conductivity of the fatty acid and a decreased conductivity relative to a conductivity of choline.

In some embodiments, the composition is clear. In some embodiments, the composition is turbid. In some embodiments, the composition is opaque. In some embodiments, the composition is yellow. In some embodiments, the composition is a colloidal system.

In some embodiments, the composition is formulated as a liquid, gel, cream, foam, wetting composition, or a spray. In some embodiments, the composition is formulated as a gel. In some embodiments, the spray is a foaming spray.

In some embodiments, the composition further comprises a viscosity enhancing agent, a viscosity modifying agent, an alcohol, an emollient, pH adjuster, skin conditioner, drying time enhancer, dye, fragrance, humectant, emollient, or a combination thereof. In some embodiments, the viscosity enhancing agent or the viscosity modifying agent is also a bulking agent.

Suitable alcohols for use with the sanitizers of the present disclosure can include any water-soluble alcohol known in the art. In some embodiments, the alcohol is a short chain alcohol. Non-limiting examples of suitable alcohols include methanol, ethanol, n-propanol, isopropyl alcohol, butanol, t-butanol, 2-butanol, pentanol, hexanol, or combinations thereof. In certain embodiments, the alcohol is ethanol, isopropyl alcohol, or combinations thereof. In certain embodiments, the alcohol is ethanol. In one embodiment, the alcohol is a specially denatured alcohol, such as SD alcohol 40B.

In some embodiments, the sanitizing compositions of the present disclosure comprise alcohol in an amount of from about 20% to about 95% (by weight of the sanitizer). In some embodiments, the sanitizing compositions of the present disclosure comprise an alcohol in an amount of from about 25% to about 95% by weight. In some embodiments, the sanitizing compositions of the present disclosure comprise an alcohol in an amount of from about 30% to about 95% by weight. In some embodiments, the sanitizing compositions of the present disclosure comprise an alcohol in an amount of from about 35% to about 95% by weight. In some embodiments, the sanitizing compositions of the present disclosure comprise an alcohol in an amount of from about 40% to about 95% by weight. In some embodiments, the sanitizing compositions of the present disclosure comprise an alcohol in an amount of from about 45% to about 95% by weight. In some embodiments, the sanitizing compositions of the present disclosure comprise an alcohol in an amount of from about 50% to about 95% by weight. In some embodiments, the sanitizing compositions of the present disclosure comprise an alcohol in an amount of from about 55% to about 95% by weight. In some embodiments, the sanitizing compositions of the present disclosure comprise an alcohol in an amount of from about 60% to about 95% by weight. In some embodiments, the sanitizing compositions of the present disclosure comprise an alcohol in an amount of from about 65% to about 95% by weight. In some embodiments, the sanitizing compositions of the present disclosure comprise an alcohol in an amount of from about 70% to about 95% by weight. In some embodiments, the sanitizing compositions of the present disclosure comprise an alcohol in an amount of from about 75% to about 95% by weight. In some embodiments, the sanitizing compositions of the present disclosure comprise an alcohol in an amount of from about 80% to about 95% by weight. In some embodiments, the sanitizing compositions of the present disclosure comprise an alcohol in an amount of from about 85% to about 95% by weight. In some embodiments, the sanitizing compositions of the present disclosure comprise an alcohol in an amount of from about 90% to about 95% by weight.

In addition to the alcohol, in certain embodiments, the sanitizing compositions of the present disclosure may optionally further comprise other disinfectants, antimicrobial agents, and/or sporicides that contribute to the anti-microbial effect of the sanitizer.

In some embodiments, the sanitizers of the present disclosure further comprise one or more moisturizers or other skin protectants, such as an emollient and/or a silicone. Suitable silicone materials include, for example, a silicone surfactant, a volatile silicone oil, a non-volatile silicone oil, or combinations thereof. More particularly, the silicone material may be, for example, dimethicone, cyclomethicone, polyalkylsiloxanes, polyarylsiloxanes, polyalkylarylsiloxanes, polysiloxane gums, polyether siloxane copolymers, and combinations thereof. Exemplary silicone and silicone derivatives also include branched or linear cyclical silicone or silicone derivatives, cyclomethicone, dimethicone polysiloxane, dimethiconol, polysiloxanes, polysiloxane copolymers, polyalkyl aryl silanes, polyaryl siloxanes, polyalkyl siloxanes, polyalkyl aryl silanes, polysiloxane copolymers, alkyl dimethicones, alkyl methicones, alkyldimethicone copolyols, phenyl silicones, alkyl trimethylsilanes, cyclopentasiloxane, dimethicone crosspolymer, trisiloxane, and combinations thereof. Examples of silicones include low viscosity dimethicone, phenyl trimethicione, and silicone fluid DC 345 (available from Dow Corning).

In some embodiments, the emulsifiers have a hydrophilic/lipophilic balance (HLB) of from 2 to 25 and behave as water-in-oil emulsifiers or oil-in-water emulsifiers. Suitable carbon based emulsifiers include sorbitan laurate, sorbitan palmitate, sorbitan stearate, sorbitan oleate, sorbitan sesquioleate, sorbitan trioleate, sorbitan isostearate, isoceteth-20, PEG-40 sorbitan peroleate, PEG-40 hydrogenated castor oil, laureth-4, laureth-23, ceteth-2, ceteth-10, ceteth-20, steareth-2, steareth-10, steareth-20, oleth-2 oleth-10, oleth-20, steareth-21, laureth-23, PEG-8 stearate, PEG-20 stearate, glyceryl stearate, hydrogenated vegetable glycerides phosphate, polyglyceryl-3-diisostearate, polyglyceryl-4 oleate, poloxamer 335, or combinations thereof.

In some embodiments, the more concentrated the alcohol in the sanitizer, the more potent the antimicrobial effect. However, increasing the alcohol concentration may have the effect of increasing the level of skin irritancy for certain users of the sanitizer.

In some embodiments, the composition further comprises a surfactant to solubilize, stability, and/or provide other beneficial properties to the sanitizing composition. Suitable surfactants include, but are not limited to, sodium lauryl sulfate, sodium docusate, Tween 60 or 80, triacetin, vitamin E TPGS, phospholipids, lecithins, phosphatidyl cholines (c8-c18), phosphatidylethanolamines (c8-c18), phosphatidylglycerols (c8-c18), sorbitan monooleate, polyoxyethylene sorbitan monooleate, polysorbates, polaxomers, bile salts, glyceryl monostearate, copolymers of ethylene oxide and propylene oxide, e.g., Pluronic® (BASF), and the like. Some other surfactants include polyoxyethylene fatty acid glycerides and vegetable oils, e.g., polyoxyethylene (60) hydrogenated castor oil; and polyoxyethylene alkylethers and alkylphenyl ethers, e.g., octoxynol 10, octoxynol 40.

In some embodiments, the surfactant is a non-ionic surfactant. In some embodiments, the non-ionic surfactant is poloxamer or polysorbate 60. In some embodiments, the poloxamer is a Pluronic®, Kolliphor®, or Synperonic®. In some embodiments, the poloxamer is Poloxamer 407, Poloxamer 188, Poloxamer 335, or the like, In some embodiments, the poloxamer is Poloxamer 407.

In some embodiments, the non-ionic surfactant comprises a concentration in the composition ranging from about 0.1% to about 20% by weight. In some embodiments, the sanitizing compositions of the present disclosure comprise one or more surfactants in an amount of from about 0.01% to about 10% (by weight of the sanitizer). In some embodiments, the sanitizing compositions of the present disclosure comprise one or more surfactants in an amount of from about 0.05% to about 10% by weight. In some embodiments, the sanitizing compositions of the present disclosure comprise one or more surfactants in an amount of from about 0.1% to about 10% by weight. In some embodiments, the sanitizing compositions of the present disclosure comprise one or more surfactants in an amount of from about 0.5% to about 10% by weight. In some embodiments, the sanitizing compositions of the present disclosure comprise one or more surfactants in an amount of from about 1.0% to about 10% by weight. In some embodiments, the sanitizing compositions of the present disclosure comprise one or more surfactants in an amount of from about 1.5% to about 10% by weight. In some embodiments, the sanitizing compositions of the present disclosure comprise one or more surfactants in an amount of from about 2.0% to about 10% by weight. In some embodiments, the sanitizing compositions of the present disclosure comprise one or more surfactants in an amount of from about 2.5% to about 10% by weight. In some embodiments, the sanitizing compositions of the present disclosure comprise one or more surfactants in an amount of from about 3.0% to about 10% by weight. In some embodiments, the sanitizing compositions of the present disclosure comprise one or more surfactants in an amount of from about 3.5% to about 10% by weight. In some embodiments, the sanitizing compositions of the present disclosure comprise one or more surfactants in an amount of from about 4.0% to about 10% by weight. In some embodiments, the sanitizing compositions of the present disclosure comprise one or more surfactants in an amount of from about 4.5% to about 10% by weight. In some embodiments, the sanitizing compositions of the present disclosure comprise one or more surfactants in an amount of from about 5.0% to about 10% by weight. In some embodiments, the sanitizing compositions of the present disclosure comprise one or more surfactants in an amount of from about 5.5% to about 10% by weight. In some embodiments, the sanitizing compositions of the present disclosure comprise one or more surfactants in an amount of from about 6.0% to about 10% by weight. In some embodiments, the sanitizing compositions of the present disclosure comprise one or more surfactants in an amount of from about 6.5% to about 10% by weight. In some embodiments, the sanitizing compositions of the present disclosure comprise one or more surfactants in an amount of from about 7.0% to about 10% by weight. In some embodiments, the sanitizing compositions of the present disclosure comprise one or more surfactants in an amount of from about 7.5% to about 10% by weight. In some embodiments, the sanitizing compositions of the present disclosure comprise one or more surfactants in an amount of from about 8.0% to about 10% by weight. In some embodiments, the sanitizing compositions of the present disclosure comprise one or more surfactants in an amount of from about 8.5% to about 10% by weight. In some embodiments, the sanitizing compositions of the present disclosure comprise one or more surfactants in an amount of from about 9.0% to about 10% by weight. In some embodiments, the sanitizing compositions of the present disclosure comprise one or more surfactants in an amount of from about 9.5% to about 10% by weight.

In some embodiments, the sanitizing compositions of the present disclosure comprise one or more surfactants in an amount of from about 0.01% to about 9.5% (by weight of the sanitizer). In some embodiments, the sanitizing compositions of the present disclosure comprise one or more surfactants in an amount of from about 0.05% to about 9.5% by weight. In some embodiments, the sanitizing compositions of the present disclosure comprise one or more surfactants in an amount of from about 0.1% to about 9.5% by weight. In some embodiments, the sanitizing compositions of the present disclosure comprise one or more surfactants in an amount of from about 0.5% to about 9.5% by weight. In some embodiments, the sanitizing compositions of the present disclosure comprise one or more surfactants in an amount of from about 1.0% to about 9.5% by weight. In some embodiments, the sanitizing compositions of the present disclosure comprise one or more surfactants in an amount of from about 1.5% to about 9.5% by weight. In some embodiments, the sanitizing compositions of the present disclosure comprise one or more surfactants in an amount of from about 2.0% to about 9.5% by weight. In some embodiments, the sanitizing compositions of the present disclosure comprise one or more surfactants in an amount of from about 2.5% to about 9.5% by weight. In some embodiments, the sanitizing compositions of the present disclosure comprise one or more surfactants in an amount of from about 3.0% to about 9.5% by weight. In some embodiments, the sanitizing compositions of the present disclosure comprise one or more surfactants in an amount of from about 3.5% to about 9.5% by weight. In some embodiments, the sanitizing compositions of the present disclosure comprise one or more surfactants in an amount of from about 4.0% to about 9.5% by weight. In some embodiments, the sanitizing compositions of the present disclosure comprise one or more surfactants in an amount of from about 4.5% to about 9.5% by weight. In some embodiments, the sanitizing compositions of the present disclosure comprise one or more surfactants in an amount of from about 5.0% to about 9.5% by weight. In some embodiments, the sanitizing compositions of the present disclosure comprise one or more surfactants in an amount of from about 5.5% to about 9.5% by weight. In some embodiments, the sanitizing compositions of the present disclosure comprise one or more surfactants in an amount of from about 6.0% to about 9.5% by weight. In some embodiments, the sanitizing compositions of the present disclosure comprise one or more surfactants in an amount of from about 6.5% to about 9.5% by weight. In some embodiments, the sanitizing compositions of the present disclosure comprise one or more surfactants in an amount of from about 7.0% to about 9.5% by weight. In some embodiments, the sanitizing compositions of the present disclosure comprise one or more surfactants in an amount of from about 7.5% to about 9.5% by weight. In some embodiments, the sanitizing compositions of the present disclosure comprise one or more surfactants in an amount of from about 8.0% to about 9.5% by weight. In some embodiments, the sanitizing compositions of the present disclosure comprise one or more surfactants in an amount of from about 8.5% to about 9.5% by weight. In some embodiments, the sanitizing compositions of the present disclosure comprise one or more surfactants in an amount of from about 9.0% to about 9.5% by weight.

In some embodiments, the sanitizing compositions of the present disclosure comprise one or more surfactants in an amount of from about 0.01% to about 9.0% (by weight of the sanitizer). In some embodiments, the sanitizing compositions of the present disclosure comprise one or more surfactants in an amount of from about 0.05% to about 9.0% by weight. In some embodiments, the sanitizing compositions of the present disclosure comprise one or more surfactants in an amount of from about 0.1% to about 9.0% by weight. In some embodiments, the sanitizing compositions of the present disclosure comprise one or more surfactants in an amount of from about 0.5% to about 9.0% by weight. In some embodiments, the sanitizing compositions of the present disclosure comprise one or more surfactants in an amount of from about 1.0% to about 9.0% by weight. In some embodiments, the sanitizing compositions of the present disclosure comprise one or more surfactants in an amount of from about 1.5% to about 9.0% by weight. In some embodiments, the sanitizing compositions of the present disclosure comprise one or more surfactants in an amount of from about 2.0% to about 9.0% by weight. In some embodiments, the sanitizing compositions of the present disclosure comprise one or more surfactants in an amount of from about 2.5% to about 9.0% by weight. In some embodiments, the sanitizing compositions of the present disclosure comprise one or more surfactants in an amount of from about 3.0% to about 9.0% by weight. In some embodiments, the sanitizing compositions of the present disclosure comprise one or more surfactants in an amount of from about 3.5% to about 9.0% by weight. In some embodiments, the sanitizing compositions of the present disclosure comprise one or more surfactants in an amount of from about 4.0% to about 9.0% by weight. In some embodiments, the sanitizing compositions of the present disclosure comprise one or more surfactants in an amount of from about 4.5% to about 9.0% by weight. In some embodiments, the sanitizing compositions of the present disclosure comprise one or more surfactants in an amount of from about 5.0% to about 9.0% by weight. In some embodiments, the sanitizing compositions of the present disclosure comprise one or more surfactants in an amount of from about 5.5% to about 9.0% by weight. In some embodiments, the sanitizing compositions of the present disclosure comprise one or more surfactants in an amount of from about 6.0% to about 9.0% by weight. In some embodiments, the sanitizing compositions of the present disclosure comprise one or more surfactants in an amount of from about 6.5% to about 9.0% by weight. In some embodiments, the sanitizing compositions of the present disclosure comprise one or more surfactants in an amount of from about 7.0% to about 9.0% by weight. In some embodiments, the sanitizing compositions of the present disclosure comprise one or more surfactants in an amount of from about 7.5% to about 9.0% by weight. In some embodiments, the sanitizing compositions of the present disclosure comprise one or more surfactants in an amount of from about 8.0% to about 9.0% by weight. In some embodiments, the sanitizing compositions of the present disclosure comprise one or more surfactants in an amount of from about 8.5% to about 9.0% by weight.

In some embodiments, the sanitizing compositions of the present disclosure comprise one or more surfactants in an amount of from about 0.01% to about 8.5% (by weight of the sanitizer). In some embodiments, the sanitizing compositions of the present disclosure comprise one or more surfactants in an amount of from about 0.05% to about 8.5% by weight. In some embodiments, the sanitizing compositions of the present disclosure comprise one or more surfactants in an amount of from about 0.1% to about 8.5% by weight. In some embodiments, the sanitizing compositions of the present disclosure comprise one or more surfactants in an amount of from about 0.5% to about 8.5% by weight. In some embodiments, the sanitizing compositions of the present disclosure comprise one or more surfactants in an amount of from about 1.0% to about 8.5% by weight. In some embodiments, the sanitizing compositions of the present disclosure comprise one or more surfactants in an amount of from about 1.5% to about 8.5% by weight. In some embodiments, the sanitizing compositions of the present disclosure comprise one or more surfactants in an amount of from about 2.0% to about 8.5% by weight. In some embodiments, the sanitizing compositions of the present disclosure comprise one or more surfactants in an amount of from about 2.5% to about 8.5% by weight. In some embodiments, the sanitizing compositions of the present disclosure comprise one or more surfactants in an amount of from about 3.0% to about 8.5% by weight. In some embodiments, the sanitizing compositions of the present disclosure comprise one or more surfactants in an amount of from about 3.5% to about 8.5% by weight. In some embodiments, the sanitizing compositions of the present disclosure comprise one or more surfactants in an amount of from about 4.0% to about 8.5% by weight. In some embodiments, the sanitizing compositions of the present disclosure comprise one or more surfactants in an amount of from about 4.5% to about 8.5% by weight. In some embodiments, the sanitizing compositions of the present disclosure comprise one or more surfactants in an amount of from about 5.0% to about 8.5% by weight. In some embodiments, the sanitizing compositions of the present disclosure comprise one or more surfactants in an amount of from about 5.5% to about 8.5% by weight. In some embodiments, the sanitizing compositions of the present disclosure comprise one or more surfactants in an amount of from about 6.0% to about 8.5% by weight. In some embodiments, the sanitizing compositions of the present disclosure comprise one or more surfactants in an amount of from about 6.5% to about 8.5% by weight. In some embodiments, the sanitizing compositions of the present disclosure comprise one or more surfactants in an amount of from about 7.0% to about 8.5% by weight. In some embodiments, the sanitizing compositions of the present disclosure comprise one or more surfactants in an amount of from about 7.5% to about 8.5% by weight. In some embodiments, the sanitizing compositions of the present disclosure comprise one or more surfactants in an amount of from about 8.0% to about 8.5% by weight.

In some embodiments, the sanitizing compositions of the present disclosure comprise one or more surfactants in an amount of from about 0.01% to about 8.0% (by weight of the sanitizer). In some embodiments, the sanitizing compositions of the present disclosure comprise one or more surfactants in an amount of from about 0.05% to about 8.0% by weight. In some embodiments, the sanitizing compositions of the present disclosure comprise one or more surfactants in an amount of from about 0.1% to about 8.0% by weight. In some embodiments, the sanitizing compositions of the present disclosure comprise one or more surfactants in an amount of from about 0.5% to about 8.0% by weight. In some embodiments, the sanitizing compositions of the present disclosure comprise one or more surfactants in an amount of from about 1.0% to about 8.0% by weight. In some embodiments, the sanitizing compositions of the present disclosure comprise one or more surfactants in an amount of from about 1.5% to about 8.0% by weight. In some embodiments, the sanitizing compositions of the present disclosure comprise one or more surfactants in an amount of from about 2.0% to about 8.0% by weight. In some embodiments, the sanitizing compositions of the present disclosure comprise one or more surfactants in an amount of from about 2.5% to about 8.0% by weight. In some embodiments, the sanitizing compositions of the present disclosure comprise one or more surfactants in an amount of from about 3.0% to about 8.0% by weight. In some embodiments, the sanitizing compositions of the present disclosure comprise one or more surfactants in an amount of from about 3.5% to about 8.0% by weight. In some embodiments, the sanitizing compositions of the present disclosure comprise one or more surfactants in an amount of from about 4.0% to about 8.0% by weight. In some embodiments, the sanitizing compositions of the present disclosure comprise one or more surfactants in an amount of from about 4.5% to about 8.0% by weight. In some embodiments, the sanitizing compositions of the present disclosure comprise one or more surfactants in an amount of from about 5.0% to about 8.0% by weight. In some embodiments, the sanitizing compositions of the present disclosure comprise one or more surfactants in an amount of from about 5.5% to about 8.0% by weight. In some embodiments, the sanitizing compositions of the present disclosure comprise one or more surfactants in an amount of from about 6.0% to about 8.0% by weight. In some embodiments, the sanitizing compositions of the present disclosure comprise one or more surfactants in an amount of from about 6.5% to about 8.0% by weight. In some embodiments, the sanitizing compositions of the present disclosure comprise one or more surfactants in an amount of from about 7.0% to about 8.0% by weight. In some embodiments, the sanitizing compositions of the present disclosure comprise one or more surfactants in an amount of from about 7.5% to about 8.0% by weight.

In some embodiments, the sanitizing compositions of the present disclosure comprise one or more surfactants in an amount of from about 0.01% to about 7.5% (by weight of the sanitizer). In some embodiments, the sanitizing compositions of the present disclosure comprise one or more surfactants in an amount of from about 0.05% to about 7.5% by weight. In some embodiments, the sanitizing compositions of the present disclosure comprise one or more surfactants in an amount of from about 0.1% to about 7.5% by weight. In some embodiments, the sanitizing compositions of the present disclosure comprise one or more surfactants in an amount of from about 0.5% to about 7.5% by weight. In some embodiments, the sanitizing compositions of the present disclosure comprise one or more surfactants in an amount of from about 1.0% to about 7.5% by weight. In some embodiments, the sanitizing compositions of the present disclosure comprise one or more surfactants in an amount of from about 1.5% to about 7.5% by weight. In some embodiments, the sanitizing compositions of the present disclosure comprise one or more surfactants in an amount of from about 2.0% to about 7.5% by weight. In some embodiments, the sanitizing compositions of the present disclosure comprise one or more surfactants in an amount of from about 2.5% to about 7.5% by weight. In some embodiments, the sanitizing compositions of the present disclosure comprise one or more surfactants in an amount of from about 3.0% to about 7.5% by weight. In some embodiments, the sanitizing compositions of the present disclosure comprise one or more surfactants in an amount of from about 3.5% to about 7.5% by weight. In some embodiments, the sanitizing compositions of the present disclosure comprise one or more surfactants in an amount of from about 4.0% to about 7.5% by weight. In some embodiments, the sanitizing compositions of the present disclosure comprise one or more surfactants in an amount of from about 4.5% to about 7.5% by weight. In some embodiments, the sanitizing compositions of the present disclosure comprise one or more surfactants in an amount of from about 5.0% to about 7.5% by weight. In some embodiments, the sanitizing compositions of the present disclosure comprise one or more surfactants in an amount of from about 5.5% to about 7.5% by weight. In some embodiments, the sanitizing compositions of the present disclosure comprise one or more surfactants in an amount of from about 6.0% to about 7.5% by weight. In some embodiments, the sanitizing compositions of the present disclosure comprise one or more surfactants in an amount of from about 6.5% to about 7.5% by weight. In some embodiments, the sanitizing compositions of the present disclosure comprise one or more surfactants in an amount of from about 7.0% to about 7.5% by weight.

In some embodiments, the sanitizing compositions of the present disclosure comprise one or more surfactants in an amount of from about 0.01% to about 7.0% (by weight of the sanitizer). In some embodiments, the sanitizing compositions of the present disclosure comprise one or more surfactants in an amount of from about 0.05% to about 7.0% by weight. In some embodiments, the sanitizing compositions of the present disclosure comprise one or more surfactants in an amount of from about 0.1% to about 7.0% by weight. In some embodiments, the sanitizing compositions of the present disclosure comprise one or more surfactants in an amount of from about 0.5% to about 7.0% by weight. In some embodiments, the sanitizing compositions of the present disclosure comprise one or more surfactants in an amount of from about 1.0% to about 7.0% by weight. In some embodiments, the sanitizing compositions of the present disclosure comprise one or more surfactants in an amount of from about 1.5% to about 7.0% by weight. In some embodiments, the sanitizing compositions of the present disclosure comprise one or more surfactants in an amount of from about 2.0% to about 7.0% by weight. In some embodiments, the sanitizing compositions of the present disclosure comprise one or more surfactants in an amount of from about 2.5% to about 7.0% by weight. In some embodiments, the sanitizing compositions of the present disclosure comprise one or more surfactants in an amount of from about 3.0% to about 7.0% by weight. In some embodiments, the sanitizing compositions of the present disclosure comprise one or more surfactants in an amount of from about 3.5% to about 7.0% by weight. In some embodiments, the sanitizing compositions of the present disclosure comprise one or more surfactants in an amount of from about 4.0% to about 7.0% by weight. In some embodiments, the sanitizing compositions of the present disclosure comprise one or more surfactants in an amount of from about 4.5% to about 7.0% by weight. In some embodiments, the sanitizing compositions of the present disclosure comprise one or more surfactants in an amount of from about 5.0% to about 7.0% by weight. In some embodiments, the sanitizing compositions of the present disclosure comprise one or more surfactants in an amount of from about 5.5% to about 7.0% by weight. In some embodiments, the sanitizing compositions of the present disclosure comprise one or more surfactants in an amount of from about 6.0% to about 7.0% by weight. In some embodiments, the sanitizing compositions of the present disclosure comprise one or more surfactants in an amount of from about 6.5% to about 7.0% by weight.

In some embodiments, the sanitizing compositions of the present disclosure comprise one or more surfactants in an amount of from about 0.01% to about 6.5% (by weight of the sanitizer). In some embodiments, the sanitizing compositions of the present disclosure comprise one or more surfactants in an amount of from about 0.05% to about 6.5% by weight. In some embodiments, the sanitizing compositions of the present disclosure comprise one or more surfactants in an amount of from about 0.1% to about 6.5% by weight. In some embodiments, the sanitizing compositions of the present disclosure comprise one or more surfactants in an amount of from about 0.5% to about 6.5% by weight. In some embodiments, the sanitizing compositions of the present disclosure comprise one or more surfactants in an amount of from about 1.0% to about 6.5% by weight. In some embodiments, the sanitizing compositions of the present disclosure comprise one or more surfactants in an amount of from about 1.5% to about 6.5% by weight. In some embodiments, the sanitizing compositions of the present disclosure comprise one or more surfactants in an amount of from about 2.0% to about 6.5% by weight. In some embodiments, the sanitizing compositions of the present disclosure comprise one or more surfactants in an amount of from about 2.5% to about 6.5% by weight. In some embodiments, the sanitizing compositions of the present disclosure comprise one or more surfactants in an amount of from about 3.0% to about 6.5% by weight. In some embodiments, the sanitizing compositions of the present disclosure comprise one or more surfactants in an amount of from about 3.5% to about 6.5% by weight. In some embodiments, the sanitizing compositions of the present disclosure comprise one or more surfactants in an amount of from about 4.0% to about 6.5% by weight. In some embodiments, the sanitizing compositions of the present disclosure comprise one or more surfactants in an amount of from about 4.5% to about 6.5% by weight. In some embodiments, the sanitizing compositions of the present disclosure comprise one or more surfactants in an amount of from about 5.0% to about 6.5% by weight. In some embodiments, the sanitizing compositions of the present disclosure comprise one or more surfactants in an amount of from about 5.5% to about 6.5% by weight. In some embodiments, the sanitizing compositions of the present disclosure comprise one or more surfactants in an amount of from about 6.0% to about 6.5% by weight.

In some embodiments, the sanitizing compositions of the present disclosure comprise one or more surfactants in an amount of from about 0.01% to about 6.0% (by weight of the sanitizer). In some embodiments, the sanitizing compositions of the present disclosure comprise one or more surfactants in an amount of from about 0.05% to about 6.0% by weight. In some embodiments, the sanitizing compositions of the present disclosure comprise one or more surfactants in an amount of from about 0.1% to about 6.0% by weight. In some embodiments, the sanitizing compositions of the present disclosure comprise one or more surfactants in an amount of from about 0.5% to about 6.0% by weight. In some embodiments, the sanitizing compositions of the present disclosure comprise one or more surfactants in an amount of from about 1.0% to about 6.0% by weight. In some embodiments, the sanitizing compositions of the present disclosure comprise one or more surfactants in an amount of from about 1.5% to about 6.0% by weight. In some embodiments, the sanitizing compositions of the present disclosure comprise one or more surfactants in an amount of from about 2.0% to about 6.0% by weight. In some embodiments, the sanitizing compositions of the present disclosure comprise one or more surfactants in an amount of from about 2.5% to about 6.0% by weight. In some embodiments, the sanitizing compositions of the present disclosure comprise one or more surfactants in an amount of from about 3.0% to about 6.0% by weight. In some embodiments, the sanitizing compositions of the present disclosure comprise one or more surfactants in an amount of from about 3.5% to about 6.0% by weight. In some embodiments, the sanitizing compositions of the present disclosure comprise one or more surfactants in an amount of from about 4.0% to about 6.0% by weight. In some embodiments, the sanitizing compositions of the present disclosure comprise one or more surfactants in an amount of from about 4.5% to about 6.0% by weight. In some embodiments, the sanitizing compositions of the present disclosure comprise one or more surfactants in an amount of from about 5.0% to about 6.0% by weight. In some embodiments, the sanitizing compositions of the present disclosure comprise one or more surfactants in an amount of from about 5.5% to about 6.0% by weight.

In some embodiments, the sanitizing compositions of the present disclosure comprise one or more surfactants in an amount of from about 0.01% to about 5.5% (by weight of the sanitizer). In some embodiments, the sanitizing compositions of the present disclosure comprise one or more surfactants in an amount of from about 0.05% to about 5.5% by weight. In some embodiments, the sanitizing compositions of the present disclosure comprise one or more surfactants in an amount of from about 0.1% to about 5.5% by weight. In some embodiments, the sanitizing compositions of the present disclosure comprise one or more surfactants in an amount of from about 0.5% to about 5.5% by weight. In some embodiments, the sanitizing compositions of the present disclosure comprise one or more surfactants in an amount of from about 1.0% to about 5.5% by weight. In some embodiments, the sanitizing compositions of the present disclosure comprise one or more surfactants in an amount of from about 1.5% to about 5.5% by weight. In some embodiments, the sanitizing compositions of the present disclosure comprise one or more surfactants in an amount of from about 2.0% to about 5.5% by weight. In some embodiments, the sanitizing compositions of the present disclosure comprise one or more surfactants in an amount of from about 2.5% to about 5.5% by weight. In some embodiments, the sanitizing compositions of the present disclosure comprise one or more surfactants in an amount of from about 3.0% to about 5.5% by weight. In some embodiments, the sanitizing compositions of the present disclosure comprise one or more surfactants in an amount of from about 3.5% to about 5.5% by weight. In some embodiments, the sanitizing compositions of the present disclosure comprise one or more surfactants in an amount of from about 4.0% to about 5.5% by weight. In some embodiments, the sanitizing compositions of the present disclosure comprise one or more surfactants in an amount of from about 4.5% to about 5.5% by weight.

In some embodiments, the sanitizing compositions of the present disclosure comprise one or more surfactants in an amount of from about 0.01% to about 5.0% (by weight of the sanitizer). In some embodiments, the sanitizing compositions of the present disclosure comprise one or more surfactants in an amount of from about 0.05% to about 5.0% by weight. In some embodiments, the sanitizing compositions of the present disclosure comprise one or more surfactants in an amount of from about 0.1% to about 5.0% by weight. In some embodiments, the sanitizing compositions of the present disclosure comprise one or more surfactants in an amount of from about 0.5% to about 5.0% by weight. In some embodiments, the sanitizing compositions of the present disclosure comprise one or more surfactants in an amount of from about 1.0% to about 5.0% by weight. In some embodiments, the sanitizing compositions of the present disclosure comprise one or more surfactants in an amount of from about 1.5% to about 5.0% by weight. In some embodiments, the sanitizing compositions of the present disclosure comprise one or more surfactants in an amount of from about 2.0% to about 5.0% by weight. In some embodiments, the sanitizing compositions of the present disclosure comprise one or more surfactants in an amount of from about 2.5% to about 5.0% by weight. In some embodiments, the sanitizing compositions of the present disclosure comprise one or more surfactants in an amount of from about 3.0% to about 5.0% by weight. In some embodiments, the sanitizing compositions of the present disclosure comprise one or more surfactants in an amount of from about 3.5% to about 5.0% by weight. In some embodiments, the sanitizing compositions of the present disclosure comprise one or more surfactants in an amount of from about 4.0% to about 5.0% by weight. In some embodiments, the sanitizing compositions of the present disclosure comprise one or more surfactants in an amount of from about 4.5% to about 5.0% by weight.

In some embodiments, the sanitizing compositions of the present disclosure comprise one or more surfactants in an amount of from about 0.01% to about 4.5% (by weight of the sanitizer). In some embodiments, the sanitizing compositions of the present disclosure comprise one or more surfactants in an amount of from about 0.05% to about 4.5% by weight. In some embodiments, the sanitizing compositions of the present disclosure comprise one or more surfactants in an amount of from about 0.1% to about 4.5% by weight. In some embodiments, the sanitizing compositions of the present disclosure comprise one or more surfactants in an amount of from about 0.5% to about 4.5% by weight. In some embodiments, the sanitizing compositions of the present disclosure comprise one or more surfactants in an amount of from about 1.0% to about 4.5% by weight. In some embodiments, the sanitizing compositions of the present disclosure comprise one or more surfactants in an amount of from about 1.5% to about 4.5% by weight. In some embodiments, the sanitizing compositions of the present disclosure comprise one or more surfactants in an amount of from about 2.0% to about 4.5% by weight. In some embodiments, the sanitizing compositions of the present disclosure comprise one or more surfactants in an amount of from about 2.5% to about 4.5% by weight. In some embodiments, the sanitizing compositions of the present disclosure comprise one or more surfactants in an amount of from about 3.0% to about 4.5% by weight. In some embodiments, the sanitizing compositions of the present disclosure comprise one or more surfactants in an amount of from about 3.5% to about 4.5% by weight. In some embodiments, the sanitizing compositions of the present disclosure comprise one or more surfactants in an amount of from about 4.0% to about 4.5% by weight.

In some embodiments, the sanitizing compositions of the present disclosure comprise one or more surfactants in an amount of from about 0.01% to about 4.0% (by weight of the sanitizer). In some embodiments, the sanitizing compositions of the present disclosure comprise one or more surfactants in an amount of from about 0.05% to about 4.0% by weight. In some embodiments, the sanitizing compositions of the present disclosure comprise one or more surfactants in an amount of from about 0.1% to about 4.0% by weight. In some embodiments, the sanitizing compositions of the present disclosure comprise one or more surfactants in an amount of from about 0.5% to about 4.0% by weight. In some embodiments, the sanitizing compositions of the present disclosure comprise one or more surfactants in an amount of from about 1.0% to about 4.0% by weight. In some embodiments, the sanitizing compositions of the present disclosure comprise one or more surfactants in an amount of from about 1.5% to about 4.0% by weight. In some embodiments, the sanitizing compositions of the present disclosure comprise one or more surfactants in an amount of from about 2.0% to about 4.0% by weight. In some embodiments, the sanitizing compositions of the present disclosure comprise one or more surfactants in an amount of from about 2.5% to about 4.0% by weight. In some embodiments, the sanitizing compositions of the present disclosure comprise one or more surfactants in an amount of from about 3.0% to about 4.0% by weight. In some embodiments, the sanitizing compositions of the present disclosure comprise one or more surfactants in an amount of from about 3.5% to about 4.0% by weight.

In some embodiments, the sanitizing compositions of the present disclosure comprise one or more surfactants in an amount of from about 0.01% to about 3.5% (by weight of the sanitizer). In some embodiments, the sanitizing compositions of the present disclosure comprise one or more surfactants in an amount of from about 0.05% to about 3.5% by weight. In some embodiments, the sanitizing compositions of the present disclosure comprise one or more surfactants in an amount of from about 0.1% to about 3.5% by weight. In some embodiments, the sanitizing compositions of the present disclosure comprise one or more surfactants in an amount of from about 0.5% to about 3.5% by weight. In some embodiments, the sanitizing compositions of the present disclosure comprise one or more surfactants in an amount of from about 1.0% to about 3.5% by weight. In some embodiments, the sanitizing compositions of the present disclosure comprise one or more surfactants in an amount of from about 1.5% to about 3.5% by weight. In some embodiments, the sanitizing compositions of the present disclosure comprise one or more surfactants in an amount of from about 2.0% to about 3.5% by weight. In some embodiments, the sanitizing compositions of the present disclosure comprise one or more surfactants in an amount of from about 2.5% to about 3.5% by weight. In some embodiments, the sanitizing compositions of the present disclosure comprise one or more surfactants in an amount of from about 3.0% to about 3.5% by weight.

In some embodiments, the sanitizing compositions of the present disclosure comprise one or more surfactants in an amount of from about 0.01% to about 3.0% (by weight of the sanitizer). In some embodiments, the sanitizing compositions of the present disclosure comprise one or more surfactants in an amount of from about 0.05% to about 3.0% by weight. In some embodiments, the sanitizing compositions of the present disclosure comprise one or more surfactants in an amount of from about 0.1% to about 3.0% by weight. In some embodiments, the sanitizing compositions of the present disclosure comprise one or more surfactants in an amount of from about 0.5% to about 3.0% by weight. In some embodiments, the sanitizing compositions of the present disclosure comprise one or more surfactants in an amount of from about 1.0% to about 3.0% by weight. In some embodiments, the sanitizing compositions of the present disclosure comprise one or more surfactants in an amount of from about 1.5% to about 3.0% by weight. In some embodiments, the sanitizing compositions of the present disclosure comprise one or more surfactants in an amount of from about 2.0% to about 3.0% by weight. In some embodiments, the sanitizing compositions of the present disclosure comprise one or more surfactants in an amount of from about 2.5% to about 3.0% by weight.

In some embodiments, the sanitizing compositions of the present disclosure comprise one or more surfactants in an amount of from about 0.01% to about 2.5% (by weight of the sanitizer). In some embodiments, the sanitizing compositions of the present disclosure comprise one or more surfactants in an amount of from about 0.05% to about 2.5% by weight. In some embodiments, the sanitizing compositions of the present disclosure comprise one or more surfactants in an amount of from about 0.1% to about 2.5% by weight. In some embodiments, the sanitizing compositions of the present disclosure comprise one or more surfactants in an amount of from about 0.5% to about 2.5% by weight. In some embodiments, the sanitizing compositions of the present disclosure comprise one or more surfactants in an amount of from about 1.0% to about 2.5% by weight. In some embodiments, the sanitizing compositions of the present disclosure comprise one or more surfactants in an amount of from about 1.5% to about 2.5% by weight. In some embodiments, the sanitizing compositions of the present disclosure comprise one or more surfactants in an amount of from about 2.0% to about 2.5% by weight.

In some embodiments, the sanitizing compositions of the present disclosure comprise one or more surfactants in an amount of from about 0.01% to about 2.0% (by weight of the sanitizer). In some embodiments, the sanitizing compositions of the present disclosure comprise one or more surfactants in an amount of from about 0.05% to about 2.0% by weight. In some embodiments, the sanitizing compositions of the present disclosure comprise one or more surfactants in an amount of from about 0.1% to about 2.0% by weight. In some embodiments, the sanitizing compositions of the present disclosure comprise one or more surfactants in an amount of from about 0.5% to about 2.0% by weight. In some embodiments, the sanitizing compositions of the present disclosure comprise one or more surfactants in an amount of from about 1.0% to about 2.0% by weight. In some embodiments, the sanitizing compositions of the present disclosure comprise one or more surfactants in an amount of from about 1.5% to about 2.0% by weight.

In some embodiments, the sanitizing compositions of the present disclosure comprise one or more surfactants in an amount of from about 0.01% to about 1.5% (by weight of the sanitizer). In some embodiments, the sanitizing compositions of the present disclosure comprise one or more surfactants in an amount of from about 0.05% to about 1.5% by weight. In some embodiments, the sanitizing compositions of the present disclosure comprise one or more surfactants in an amount of from about 0.1% to about 1.5% by weight. In some embodiments, the sanitizing compositions of the present disclosure comprise one or more surfactants in an amount of from about 0.5% to about 1.5% by weight. In some embodiments, the sanitizing compositions of the present disclosure comprise one or more surfactants in an amount of from about 1.0% to about 1.5% by weight.

In some embodiments, the sanitizing compositions of the present disclosure comprise one or more surfactants in an amount of from about 0.01% to about 1.0% (by weight of the sanitizer). In some embodiments, the sanitizing compositions of the present disclosure comprise one or more surfactants in an amount of from about 0.05% to about 1.0% by weight. In some embodiments, the sanitizing compositions of the present disclosure comprise one or more surfactants in an amount of from about 0.1% to about 1.0% by weight. In some embodiments, the sanitizing compositions of the present disclosure comprise one or more surfactants in an amount of from about 0.5% to about 1.0% by weight.

In some embodiments, the sanitizing compositions of the present disclosure comprise one or more surfactants in an amount of from about 0.01% to about 0.5% (by weight of the sanitizer). In some embodiments, the sanitizing compositions of the present disclosure comprise one or more surfactants in an amount of from about 0.05% to about 0.5% by weight. In some embodiments, the sanitizing compositions of the present disclosure comprise one or more surfactants in an amount of from about 0.1% to about 0.5% by weight.

In some embodiments, the sanitizing compositions of the present disclosure comprise one or more surfactants in an amount of from about 0.01% to about 0.1% (by weight of the sanitizer). In some embodiments, the sanitizing compositions of the present disclosure comprise one or more surfactants in an amount of from about 0.05% to about 0.1% by weight.

The sanitizing compositions of the present disclosure may further comprise a carrier material such as water. In some embodiments, the water is present in the sanitizer compositions in an amount of from about 1% (by weight of the sanitizer) to about 85% (by weight of the sanitizer).

The sanitizing compositions may further comprise a fragrance. Any suitable fragrance may be used. In some embodiments, the fragrance is D-limonene. In some embodiments, the composition comprises a fragrance agent. In some embodiments, the fragrance agent comprises or is derived from essential oils, absolutes, resinoids, resins, concretes, or synthetic perfume components such as hydrocarbons, alcohols, aldehydes, ketones, ethers, acids, acetals, ketals and nitriles, including saturated and unsaturated compounds, aliphatic, carbocyclic and heterocyclic compounds, or precursors of any of the above. Exemplary fragrant agents include, but are not limited to, eucalyptus (Eucalyptus globulus or Eucalyptus citriadora), pine needles (picca excelsa), Ho-leaves (Cinnamomum camphora hosch), peppermint (Mentha piperita), neem tree (Azadirachta excelsa), bay leaves (Laurus nobilis), litsea (Litsea cubeba), citronella (Cymbopogon nardus), elemi (Canarium luzonicum), petitgrain citronniers lemon (Citrus limonum), grapefruit (citrus paradisi), fir tree (Abies alba pectinata), lavender (Lavandula officinalis), bergamotte (Citrus aurantium bergamia), and rosemary (Rosmarinus officinalis). In some embodiments, the fragrance agent is derived from a citrus fruit including but not limited to, oranges, lemons, grapefruit, and limes. In some embodiments, the fragrance agent is an acid or terpene derived from a citrus fruit. In some embodiments, the fragrance agent is citric acid or a citric acid derivative. In some embodiments, the fragrance agent is limonene.

In some embodiments, the composition comprises D-limonene. In some embodiments, the concentration of D-limonene in the composition is up to about 1.0% by weight. In some embodiments, the concentration of D-limonene in the composition is at least about 0.2% by weight. In some embodiments, the concentration of D-limonene in the composition is about 0.1%, about 0.2%, about 0.3%, about 0.4%, about 0.5%, about 0.6%, about 0.7%, about 0.8%, about 0.9%, about 1.0%, about 2.0%, about 3.0%, about 3.0%, or about 4.5% by weight. In some embodiments, the concentration of D-limonene in the composition is in a range of about 0.5% to about 4.5%, about 0.60% to about 2.0%, or about 0.2% to about 1.0% by weight. In some embodiments, the concentration of D-limonene in the composition is about 0.1, about 0.2, about 0.3, about 0.4, about 0.5, about 0.6, about 0.7, about 0.8, about 0.9, or about 1.0% by weight.

The pH of the sanitizing compositions may be controlled to be within any desired range, depending on the target surface/soil. In some embodiments, the sanitizer is formulated for topical application on a human body. In some embodiments, the sanitizer has a neutral pH. In some embodiments, various pH modifiers may be utilized in the sanitizer to achieve the desired pH level. Any suitable acid or alkali material may be used as a pH modifier. For instance, some examples of basic pH modifiers that may be used in the sanitizer include, but are not limited to, ammonia; mono-, di-, and tri-alkyl amines; mono-, di-, and tri-alkanolamines; alkali metal and alkaline earth metal hydroxides; alkali metal and alkaline earth metal silicates; and mixtures thereof. Specific examples of basic pH modifiers are ammonia; sodium, potassium, and lithium hydroxide; sodium, potassium, and lithium meta silicates; monoethanolamine; triethylamine; isopropanolamine; diethanolamine; and triethanolamine. Other examples of suitable basic pH modifiers include tris amino 40% (available from Angus Chemical Company), AMP-95 (aminomethylpropanol) (available from Angus Chemical Company), triisopropanolamine (available from Dow Chemical Company), diisopropanolamine (available from Dow Chemical Company), Neutrol® TE (tetrahydroxypropylethylenediamine) (available from BASF), and Ethomeen® C-25 (PEG-15 cocoamine) (available from Akzo Nobel).

Some examples of acidic pH modifiers that may be used in the present disclosure include, but are not limited to, mineral acids; and carboxylic acids; and polymeric acids. Specific examples of suitable mineral acids are hydrochloric acid, nitric acid, phosphoric acid, and sulfuric acid. Specific examples of suitable carboxylic acids are citric acid, glycolic acid, lactic acid, maleic acid, malic acid, succinic acid, glutaric acid, benzoic acid, malonic acid, salicylic acid, gluconic acid, and mixtures thereof. Specific examples of suitable polymeric acids include straight-chain poly(acrylic) acid and its copolymers (e.g., maleic-acrylic, sulfonic-acrylic, and styrene-acrylic copolymers), cross-linked polyacrylic acids having a molecular weight of less than about 250,000, poly(methacrylic) acid, and naturally occurring polymeric acids such as carageenic acid, and alginic acid.

In some embodiments, the pH modifier is present in the sanitizing compositions in an amount of up to about 5% (by weight of the sanitizer).

Optionally, one or more viscosity enhancers, such as thickeners, viscosity enhancing agents, and the like may be added to the sanitizing compositions to increase the viscosity of the sanitizer. Suitable viscosity enhancers include clays and derivatives thereof, silicates, silicas and derivatives thereof, and combinations thereof. Suitable clays and derivatives thereof include, but are not limited to, bentonite and derivatives thereof such as quaternium-18 bentonite, hectorite and derivatives thereof such as quaternium-18 hectorite, montmorillonite, and combinations thereof. Suitable silicates include, but are not limited to, magnesium aluminum silicate, sodium magnesium silicate, lithium magnesium silicate, tromethamine magnesium aluminum silicate, and combinations thereof. Suitable silicas and derivatives thereof include, but are not limited to, silica, hydrated silica, hydrophobic silica, silica silylate, silica methyl silylate, colloidal silicone dioxide, fumed silica, and combinations thereof.

Other examples of suitable viscosity enhancers include polyolefin resins, lipophilic/oil thickeners, ethylene/vinyl acetate copolymers, polyethylene, cetyl hydroxy ethyl cellulose, hydroxyethylcellulose, hydroxypropyl methylcellulose, hydroxypropylcellulose, other organically modified celluloses, PVP/decane copolymer, PVM/MA decadiene crosspolymer, PVP/eicosene copolymer, PVP/hexadecane copolymer, butylated PVP, carbomers, acrylic based thickeners, polyethylene glycol 600, polyethylene glycols, myristyl alcohol, cetyl alcohol, stearyl alcohol, behenyl alcohol, PEG-150 distearate, PEG-160 diisostearate, polyglyceryl-8.5 behenate/eicosadioate, disteareth-8.50 IPDI, polyacrylamidomethylpropane sulfonic acid, silicone crosspolymers, polyamide blends, and combinations thereof.

In some embodiments, the sanitizing compositions comprise one or more viscosity enhancing agents in an amount of up to about 20% (by weight of the composition). In some embodiments, the viscosity enhancing agent is present in the sanitizer in an amount of up to about 5.0% (by weight of the sanitizer). In some embodiments, the sanitizing compositions of the present disclosure comprise one or more viscosity enhancing agents in an amount of from about 0.01% to about 4.0% (by weight of the sanitizer). In some embodiments, the sanitizing compositions of the present disclosure comprise one or more viscosity enhancing agents in an amount of from about 0.01% to about 3.0% by weight. In some embodiments, the sanitizing compositions of the present disclosure comprise one or more viscosity enhancing agents in an amount of from about 0.01% to about 2.0% by weight. In some embodiments, the sanitizing compositions of the present disclosure comprise one or more viscosity enhancing agents in an amount of from about 0.01% to about 1.0% by weight. In some embodiments, the sanitizing compositions of the present disclosure comprise one or more viscosity enhancing agents in an amount of from about 0.01% to about 0.5% by weight. In some embodiments, the sanitizing compositions of the present disclosure comprise one or more viscosity enhancing agents in an amount of from about 0.05% to about 5.0% by weight. In some embodiments, the sanitizing compositions of the present disclosure comprise one or more viscosity enhancing agents in an amount of from about 0.05% to about 4.0% by weight. In some embodiments, the sanitizing compositions of the present disclosure comprise one or more viscosity enhancing agents in an amount of from about 0.05% to about 3.0% by weight. In some embodiments, the sanitizing compositions of the present disclosure comprise one or more viscosity enhancing agents in an amount of from about 0.05% to about 2.0% by weight. In some embodiments, the sanitizing compositions of the present disclosure comprise one or more viscosity enhancing agents in an amount of from about 0.5% to about 1.0% by weight. In some embodiments, the sanitizing compositions of the present disclosure comprise one or more viscosity enhancing agents in an amount of from about 0.05% to about 0.5% by weight. In some embodiments, the sanitizing compositions of the present disclosure comprise one or more viscosity enhancing agents in an amount of from about 0.1% to about 5.0% by weight. In some embodiments, the sanitizing compositions of the present disclosure comprise one or more viscosity enhancing agents in an amount of from about 0.1% to about 4.0% by weight. In some embodiments, the sanitizing compositions of the present disclosure comprise one or more viscosity enhancing agents in an amount of from about 0.1% to about 3.0% by weight. In some embodiments, the sanitizing compositions of the present disclosure comprise one or more viscosity enhancing agents in an amount of from about 0.1% to about 2.0% by weight. In some embodiments, the sanitizing compositions of the present disclosure comprise one or more viscosity enhancing agents in an amount of from about 0.1% to about 1.0% by weight. In some embodiments, the sanitizing compositions of the present disclosure comprise one or more viscosity enhancing agents in an amount of from about 0.1% to about 0.5% by weight. In some embodiments, the viscosity enhancing agents is hydroxypropyl cellulose, such as Klucel HF.

In certain embodiments, the sanitizing compositions comprise various preservatives to increase the shelf life of the sanitizer. Exemplary preservatives that can be used in the present disclosure include, but are not limited to, Kathon CG, which is a mixture of methylchloroisothiazolinone and methylisothiazolinone available from Rohm & Haas; Mackstat H 66 (available from McIntyre Group, Chicago, Ill.); DMDM hydantoin (e.g., Glydant Plus, Lonza, Inc., Fair Lawn, N.J.); tetrasodium EDTA; iodopropynyl butylcarbamate; benzoic esters (parabens), such as methylparaben, propylparaben, butylparaben, ethylparaben, isopropylparaben, isobutylparaben, benzylparaben, sodium methylparaben, and sodium propylparaben; 2-bromo-2-nitropropane-1,3-diol; benzoic acid; amidazolidinyl urea; diazolidinyl urea; and the like. Other suitable preservatives include those sold by Sutton Labs, such as “Germall 115” (amidazolidinyl urea), “Germall II” (diazolidinyl urea), and “Germall Plus” (diazolidinyl urea and iodopropynyl butylcarbonate).

When utilized, the amount of the preservative present in the sanitizer can generally vary depending on the relative amounts of the other components present within the sanitizer. For example, in some embodiments, the preservative is present in the sanitizer in an amount between about 0.001% to about 5% (by weight of the sanitizer), in some embodiments between about 0.001% to about 1% (by weight of the sanitizer), and in some embodiments, between about 0.01% to about 1% (by weight of the sanitizer).

In one embodiment, the sanitizer may additionally include one or more sequestrants or chelating agents. The sequestrants may act to enhance preservative efficacy, and bind metals that could discolor the sanitizer or hinder sanitizer stability. In particular, water often contains metal ions, such as calcium ions, that might react with anionic components (e.g., surfactants, acids, etc.) present within the sanitizer.

Some examples of sequestrants that may be used in the sanitizer of the present disclosure include, but are not limited to, ethylenediamines, ethylenediaminetetraacetic acids (EDTA) acid and/or salts thereof, citric acids and/or salts thereof, glucuronic acids and/or salts thereof, polyphosphates, organophosphates, dimercaprols, and the like.

When utilized, the amount of the sequestrants present in the sanitizer can generally vary depending on the relative amounts of the other components present within the sanitizer. For example, in some embodiments, the sequestrants are present in the sanitizer in an amount between about 0.01% to about % (by weight of the sanitizer and in some embodiments between about 0.05% to about 1.0% (by weight of the sanitizer).

In order to better enhance the sanitizer, other optional ingredients can also be used. For instance, some classes of ingredients that can be used include, but are not limited to: anti-microbial agents, antioxidants (product integrity); astringents—cosmetic (induce a tightening or tingling sensation on skin); biological additives (enhance the performance or consumer appeal of the product); film formers (to hold active ingredients on the skin by producing a continuous film on skin upon drying); hydrotropes (helps dissolve some anti-microbial agents); opacifiers (reduce the clarity or transparent appearance of the product); skin exfoliating agents (ingredients that increase the rate of skin cell turnover such as alpha hydroxy acids and beta hydroxyacids); dyes or colorants; and the like.

Examples of viscosity enhancing agents or viscosity modifying agents include, but are not limited to, as polyvinyl alcohol, polyethylene oxide, different poloxamers, carbopols, or celluloses such as ethyl cellulose, hydroxyl ethyl cellulose, hydroxyl propyl cellulose, hydroxyl propyl methyl cellulose, sulfoxides or similar compounds such as dimethylsulfoxide, dimethylsulfoxide, dimethylacetamide, dimethylformamide, pyrrolidones such as 2-pyrrolidone, N-methyl-2-pyrrolidone, 1-lauryl-2- pyrrolidone, alcohols such as ethanol, 1-octanol, 1-hexanol, 1-decanol, lauryl alcohol, linolenyl alcohol, glycols such as propylene glycol, butane-1,2-diol, polyethylene glycol 400, urea and derivatives urea, such as 1-dodecylurea, 1-dodecyl-3-methylurea,1-dodecyl-3-methylthiourea, azone and azone like molecules such as (laurocapram; 1-dodecylazacycloheptan-2-one), 1-alkyl- or 1-alkenylazacycloalkanones, enzymes acid phosphatase, calonase, papain Iminosulfuranes S,S-dimethyl-N-(5-nitro-2-pyridyl) iminosulfurane, S,S-dimethyl-N-(4-bromobenzoyl) iminosulfurane, cyclodextrins 2-hydroxypropyl-β-cyclodextrin, methylated-β-cyclodextrin, fatty acid esters such as cetyl lactate, butylacetate, isopropyl myristate, fatty acids alkanoic acids, oleic acid, lauric acid, capric acid, surfactants such as sorbitan monopalmitate, sorbitan trioleate, cetyl trimethyl ammonium bromide, sodium lauryl sulfate, terpenes such as limonene, nerolidol, farnesol, carvone, menthone, polymers such as β-D -glucopyranosyl-terminated oligodimethylsiloxanes, 1-alkyl-3-β-D -glucopyranosyl-1,1,3,3-tetramethyldisiloxanes, monoolein monoolein, noxazolidinones 4-decyloxazolidin-2-one, 3-acetyl-4-decyloxazolidin-2-one, carbomer, methyl cellulose, sodium carboxyl methyl cellulose, carrageenan, colloidal silicon dioxide, guar gum, gelatin, alginic acid, sodium alginate, and fumed silica. In some embodiments, the viscosity enhancing agent is a hydroxyethyl cellulose (HEC), hydroxypropyl cellulose (HPC), hydroxypropylmethyl cellulose (HPMC), or a combination thereof. In some embodiments, the viscosity enhancing agent is HPC.

In some embodiments, the combination of a viscosity enhancing agent and a pharmaceutically acceptable solvent is referred to as a gel base. In some embodiments, a gel base is created prior to the addition of an ionic liquid to the gel base. In some embodiments, the ionic liquid is added into the gel base. In some embodiments, the gel base is added into the ionic liquid.

In some embodiments, the gel base comprises water and a viscosity enhancing agent. In some embodiments, the gel base comprises diisopropyl adipate and a viscosity enhancing agent. In some embodiments, the gel base comprises PEG400 and a viscosity enhancing agent. In some embodiments, the gel base comprises propylene glycol and a viscosity enhancing agent. In some embodiments, the viscosity enhancing agent is HEC, HPC, or HPMC. In some embodiments, the gel base comprises ethanol and a viscosity enhancing agent. In some embodiments, the gel base further comprises glycerin, propylene glycol, ethanol, or a combination thereof.

In one example, the gel base comprises diisopropyl adipate, ethanol, glycerin, and HPC. In some embodiments, the gel base comprises 25% w/w of diisopropyl adipate, 43% w/w ethanol, 30% w/w glycerin, and 3% w/w HPC. In another example, the gel base comprises diisopropyl adipate, ethanol, propylene glycol, and HPC. In some embodiments, the gel base comprises 25% w/w of diisopropyl adipate, 13% w/w ethanol, 60% w/w propylene glycol, and 3% w/w HPC.

In some embodiments, a composition comprises a bulking agent with a concentration from 1 to 8.5% by weight. In some embodiments, a composition comprises a viscosity enhancing agent with a concentration from 1 to 8.5% by weight.

In some embodiments, the composition further comprises an inactive ingredient. In some embodiments, the inactive ingredient enhances long-term shelf storage or target area absorption. In some embodiments, the inactive ingredient is an emollient/stiffening agents/ointment, an emulsifying agent/solubilizing agent, a humectant, a preservative, a permeation enhancer, a chelating agent, an antioxidant, vehicles/solvents, pH adjusting agents, or a combination thereof.

Example of emollients/stiffening agents include, but are not limited to, carnauba wax, cetyl alcohol, cetostearyl alcohol, cetyl ester wax, emulsifying wax, hydrous lanolin, lanolin, lanolin alcohols, microcrystalline wax, paraffin, petrolatum, polyethylene glycol and polymers thereof, stearic acid, stearyl alcohol, white wax, and yellow wax. Examples of emulsifying agents/solubilizing agents include, but are not limited to, glyceryl monostearate, glyceryl monooleate, glyceryl isostearate, polysorbate 20, polysorbate 60, polysorbate 60, poloxamer, emulsifying wax, sorbitan monostearate, sorbitan monooleate, sodium lauryl sulfate, propylene glycol monostearate, diethylene glycol monoethyl ether, and docusate sodium. Examples of humectants include, but are not limited to, glycerin, propylene glycol, polyethylene glycol, sorbitol solution, and 1,2,6-hexanetriol. Examples of preservatives include, but are not limited to, benzoic acid, propyl paraben, methyl paraben, imidurea, sorbic acid, potassium sorbate, benzalkonium chloride, phenyl mercuric acetate, chlorobutanol, and phenoxyethanol. Examples of permeation enhances include, but are not limited to, propylene glycol, ethanol, isopropyl alcohol, oleic acid, and polyethylene glycol. Examples of chelating agents include, but are not limited to, ethylene diamine tetraacetate. Examples of antioxidants include, but are not limited to butylated hydroxyanisole and butylated hydroxytoluene. Examples of vehicles/solvents include, but are not limited to purified water, hexylene glycol, propylene glycol, oleyl alcohol, propylene carbonate, mineral oil, ethanol, diisopropyl adipate, polyethylene glycol (PEG), and glycerin. Examples of pH adjusting agents include, but are not limited to, acids such as acetic, boric, citric, lactic, phosphoric and hydrochloric acids; and bases such as sodium hydroxide, sodium phosphate, sodium borate, sodium citrate, sodium acetate, sodium bicarbonate, sodium lactate, ammonium chloride, and tris-hydroxymethylaminomethane. In some embodiments, the composition further comprises trolamine.

In some embodiments, the inactive ingredient is an acrylate or polymer thereof, methacrylate or polymer thereof, cellulose polymer, hydroxyethyl cellulose or polymer thereof, poly-lactylate polymer, polyvinyl pyrrolidone polymer, ethylenevinylacetate copolymer, short, medium and long chain fatty acid molecules or analog thereof, isopropryl myristate, polyethylene terephthalate, vitamin C, vitamin C analog or ester, vitamin E, vitamin E analog, vitamin E polymeric compound, d-α-tocopheryl polyethylene glycol 8.500 succinate (vitamin E TPGS), or silicone.

In some embodiments, the inactive ingredient comprises dual or multiple functionalities. For example, in one embodiment, polyethylene glycol is an emollient, humectant, and a permeation enhancer.

In some embodiments, each component in a composition, such as the ionic liquid, the pharmaceutically acceptable solvent, and optionally other components, is described a percent (%) of the composition. In some embodiments, the % of the composition is a percent concentration volume/volume (v/v), a percent concentration weight/volume (w/v), or a percent concentration weight/weight (w/w). In some embodiments, the % of the composition is a percent concentration weight/weight (w/w) (i.e., % by weight or wt. %). Unless otherwise specified, the amount of component(s) described a percent (%) of the composition refers to weight/weight (w/w) (i.e., % by weight or wt. %).

In some embodiments, the composition comprises the ionic liquid in a concentration of about 0.1% to about 99% by weight. In some embodiments, the composition comprises the ionic liquid in a concentration of about 1% to about 40% by weight. In some embodiments, the composition comprises the ionic liquid in a concentration of about 1% to about 20% by weight. In some embodiments, the composition comprises the ionic liquid in a concentration of about 5% to about 20% by weight. In some embodiments, the composition comprises the ionic liquid in a concentration of about 5% to about 40% by weight. In some embodiments, the composition comprises the ionic liquid in a concentration of about 20% to about 40% by weight. In some embodiments, the composition comprises the ionic liquid in a concentration of about 20% to about 60% by weight. In some embodiments, the composition comprises the ionic liquid in a concentration of about 20% to about 60% by weight.

In some embodiments, the composition comprises the ionic liquid in a concentration of about 0.1% to about 99%, and the pharmaceutically acceptable solvent in a concentration of about 1% to about 99.9% by weight. In some embodiments, the composition comprises the ionic liquid in a concentration of about 1% to about 40%, and the pharmaceutically acceptable solvent in a concentration of about 60% to about 99% by weight. In some embodiments, the composition comprises the ionic liquid in a concentration of about 20% to about 40%, and the pharmaceutically acceptable solvent in a concentration of about 60% to about 99% by weight. In some embodiments, the composition comprises the ionic liquid in a concentration of about 20% and the pharmaceutically acceptable solvent in a concentration of about 60% by weight. In some embodiments, the composition comprises the ionic liquid in a concentration of about 40% and the pharmaceutically acceptable solvent in a concentration of about 60% by weight.

In some embodiments, the composition further comprises ethanol. In some embodiments, the concentration of ethanol in the composition is about 65%, about 75%, about 80%, about 85%, about 90%, or about 95% by weight.

In some embodiments, the composition comprises the ionic liquid in a concentration of about 20% to 40% and a gel base in a concentration of about 20% to 60% by weight. In some embodiments, the composition comprises the ionic liquid in a concentration of 20% and a gel base in a concentration of 60% by weight. In some embodiments, the composition comprises the ionic liquid in a concentration of about 20% to 40%, propylene glycol in a concentration of 20-50%, glycerin in a concentration of 8.5-20%, ethanol in a concentration of about 8.5-20%, and hydroxyl propyl cellulose in a concentration of less than 5% by weight.

In some embodiments, the composition comprises propylene glycol. In some embodiments, the concentration of propylene glycol in the composition is about 0.05%, about 0.1%, about 0.5%, about 1.0%, about 1.5%, about 2.0%, about 2.5%, about 3.0%, about 3.5%, about 4.0%, about 4.5%, or about 5.0% by weight.

In some embodiments, the composition comprises the ionic liquid in a concentration of about 5% to 40% and a gel base comprising the pharmaceutically acceptable solvent in a concentration of about 60% to 95% by weight. In some embodiments, the composition comprises the ionic liquid in a concentration of about 5% to 40%, and a gel base in a concentration of about 60% to 95%, wherein the gel base comprises diisopropyl adipate, propylene glycol, and a poloxamer. In some embodiments, the poloxamer is a Pluronic®.

In some embodiments, the composition comprises the ionic liquid in a concentration of about 1% to 50%, and the pharmaceutically acceptable solvent in a concentration of about 50% to 99% by weight. In some embodiments, the composition comprises the ionic liquid in a concentration of about 1% to 50%, and water in a concentration of about 50% to 99% by weight. In some embodiments, the water is deionized water or Milli-Q® water.

In some embodiments, the composition comprises the ionic liquid in a concentration of about 1% to about 50%, a pharmaceutically acceptable solvent in a concentration of about 1% to 50%, and a viscosity enhancing agent in a concentration of about 1 to about 5% by weight. In some embodiments, the composition comprises the ionic liquid in a concentration of about 1% to about 50%, water in a concentration of about 1% to 50%, and HPC in a concentration of about 1 to about 5% by weight.

In some embodiments, the pharmaceutically acceptable solvent is diisopropyl adipate. In some embodiments, the composition comprises diisopropyl adipate in a concentration of about 20% by weight. In some embodiments, the composition comprises the ionic liquid in a concentration of about 1% to 40%, and diisopropyl adipate in a concentration of about 60% to about 99% by weight.

In some embodiments, the composition comprises a gel base in a concentration of about 50% to about 85% of the composition. In some embodiments, the composition comprises a gel base in a concentration of about 50%, about 60%, about 70%, about 60%, or about 85% of the composition.

In some embodiments, preparing an ionic liquid comprising a choline cation and a fatty acid anion comprises: (a) mixing choline and a fatty acid in a solvent at room temperature in a predetermined ratio; and (b) removing the solvent in vacuo. In some embodiments, the fatty acid is geranic acid. In some embodiments, the solvent is water. In a particular embodiment, the water is deionized water. In some embodiments, removing the solvent comprises rotary evaporation. In some embodiments, removing the solvent comprises heating the ionic liquid, applying a vacuum to the ionic liquid, or a combination thereof. In some embodiments, preparing the ionic liquid further comprises drying the ionic liquid. In some embodiments, heating the ionic liquid comprises heating the ionic liquid to 60° C. In some embodiments, the heating is done for at least 8.5 minutes, 20 minutes, 30 minutes, 1 hour, 2 hours, 3 hours, 4 hours, 5 hours, 6 hours, 7 hours, 8 hours, 9 hours, 8.5 hours, 11 hours, 12 hours, 24 hours, 36 hours, 48 hours or 60 hours. In some embodiments, the vacuum is applied at −8.50 kPa. In some embodiments, the vacuum is applied for at least 8.5 minutes, 20 minutes, 30 minutes, 1 hour, 2 hours, 3 hours, 4 hours, 5 hours, 6 hours, 7 hours, 8 hours, 9 hours, 8.5 hours, 11 hours, 12 hours, 24 hours, 36 hours, 48 hours or 60 hours.

In some embodiments, the ionic liquid has had the solvent used in the ionic liquid preparation process removed. In some embodiments, the ionic liquid does not comprise water.

In some embodiments, choline is choline bicarbonate. In some embodiments, the choline is choline in a 60% wt. solution of choline bicarbonate. In some embodiment, the predetermined ratio is a ratio of 1:1, 1:2, 1:3, or 1:4 of a choline cation: fatty acid anion. In one embodiment, the ratio is a molar ratio. In another embodiment, the ratio is ratio by weight.

In some embodiments, isolating the composition further comprises purifying the ionic liquid. In some embodiments, purifying the ionic liquid comprises using conventional techniques, including, but not limited to, filtration, distillation, crystallization, and chromatography. In some embodiments, preparing the ionic liquid further comprises isolating the purified ionic liquid.

### Dispensing Agents

In another aspect, the sanitizers of the present disclosure may be used in combination with a product, such as a personal care product. More particularly, the sanitizer may be incorporated into or onto a surface, such as a wipe surface, an absorbent surface, a fabric or cloth surface, or a tissue surface, among others. For example, the compositions may be incorporated into personal care products, such as wipes, absorbent articles, bath tissues, cloths, and the like. The sanitizer may be incorporated into wipes such as wipes, hand wipes, face wipes, cosmetic wipes, and the like, or absorbent articles, such as diapers, training pants, adult incontinence products, feminine hygiene products, and the like, and combinations thereof. In one embodiment, the sanitizer is a liquid composition that may be used in combination with a wipe surface to form a wipe or may be a wetting composition for use in combination with a dispersible wipe. In another embodiment, the sanitizer can be used in combination with a wipe surface, which is packaged together with one or more absorbent articles, such as diapers.

In some embodiments, the composition is applied directly to the surface. In some embodiments, the composition is placed on or in an applicator or dispenser, which then applies the composition to the surface. In some embodiments, the applicator or dispenser is a cloth, a wipe, a sponge, a mop, a squirt bottle, a spray bottle, a pump bottle, a tube, an automatic induction hand sterilizer, a bottle or container comprising a dropper, bottle or container comprising a pour spout, or a canister. In some embodiments, the spray bottle is a continuous spray bottle. In some embodiments, the spray bottle is a propellant-free continuous spray bottle. In some embodiments, the continuous spray bottle is a flairosol sprayer. In some embodiments, the spray bottle is an aerosol sprayer. In some embodiments, the spray bottle is a mist spray bottle.

### Wipes

In an aspect, provided herein is a wipe, comprising a surface retaining a releasable sanitizing composition for an inanimate surface,
wherein the sanitizing composition comprises an ionic liquid having a cationic component and an anionic component.

In an aspect, provided herein is a wipe, comprising a surface retaining a releasable sanitizing composition,
wherein the sanitizing composition comprises a deep eutectic solvent having a cationic component and an anionic component, and wherein the deep eutectic solvent has a melting point lower than the melting points of the cationic component and anionic component individually.

In some embodiments, the sanitizer is incorporated into a wetting composition for use in a wipe. The wipe may comprise a nonwoven material that is wetted with an aqueous solution termed the “wetting composition,” which may also comprise the sanitizer disclosed herein. As used herein, the nonwoven material comprises a fibrous material or surface, where the fibrous material or surface comprises a sheet that has a structure of individual fibers or filaments randomly arranged in a mat-like fashion. Nonwoven materials may be made from a variety of processes including, but not limited to, airlaid processes, wet-laid processes such as with cellulosic-based tissues or towels, hydroentangling processes, staple fiber carding and bonding, and solution spinning

The fibers forming the fibrous material may be made from a variety of materials including natural fibers, synthetic fibers, and combinations thereof. The choice of fibers may depend upon, for example, the intended end use of the finished surface and the fiber cost. For instance, suitable fibers may include, but are not limited to, natural fibers such as cotton, linen, jute, hemp, wool, wood pulp, etc. Similarly, suitable fibers may also include: regenerated cellulosic fibers, such as viscose rayon and cuprammonium rayon; modified cellulosic fibers, such as cellulose acetate; or synthetic fibers, such as those derived from polypropylenes, polyethylenes, polyolefins, polyesters, polyamides, polyacrylics, etc. Regenerated cellulose fibers, as briefly discussed above, include rayon in all its varieties as well as other fibers derived from viscose or chemically modified cellulose, including regenerated cellulose and solvent-spun cellulose, such as Lyocell. Among wood pulp fibers, any known papermaking fibers may be used, including softwood and hardwood fibers. Fibers, for example, may be chemically pulped or mechanically pulped, bleached or unbleached, virgin or recycled, high yield or low yield, and the like. Chemically treated natural cellulosic fibers may be used, such as mercerized pulps, chemically stiffened or crosslinked fibers, or sulfonated fibers.

In addition, cellulose produced by microbes and other cellulosic derivatives may be used. As used herein, the term “cellulosic” is meant to include any material having cellulose as a major constituent, and, specifically, comprising at least 50 percent by weight cellulose or a cellulose derivative. Thus, the term includes cotton, typical wood pulps, non-woody cellulosic fibers, cellulose acetate, cellulose triacetate, rayon, thermomechanical wood pulp, chemical wood pulp, debonded chemical wood pulp, milkweed, or bacterial cellulose. Blends of one or more of any of the previously described fibers may also be used, if so desired.

The fibrous material may be formed from a single layer or multiple layers. In the case of multiple layers, the layers are generally positioned in a juxtaposed or surface-to-surface relationship and all or a portion of the layers may be bound to adjacent layers. The fibrous material may also be formed from a plurality of separate fibrous materials wherein each of the separate fibrous materials may be formed from a different type of fiber.

Airlaid nonwoven fabrics are particularly well suited for use as wipes. The basis weights for airlaid nonwoven fabrics may range from about 20 to about 200 grams per square meter (gsm) with staple fibers having a denier of about 0.5-8.5 and a length of about 6-15 millimeters. Wipes may generally have a fiber density of about 0.025 g/cc to about 0.2 g/cc. Wipes may generally have a basis weight of about 20 gsm to about 150 gsm. More desirably the basis weight may be from about 30 to about 85 gsm. Even more desirably the basis weight may be from about 50 gsm to about 60 gsm.

Processes for producing airlaid non-woven base sheets are described in, for example, published U.S. Pat. App. No. 2006/0008621, herein incorporated by reference to the extent it is consistent herewith.

The wetting composition for use in combination with the nonwoven materials may desirably comprise the sanitizer of the present disclosure. As noted above, the sanitizer has efficacy against a broad spectrum of microorganisms. As such, the antimicrobial wetting composition will help keep microbiological and fungal growth in the wipe at an acceptable level.

The wetting composition may include a variety of additives or components, including those disclosed in U.S. Patent Publication No. 2002/0155281, which is incorporated herein in its entirety. Possible additives may include, but are not limited to skin-care additives, odor control additives, wetting agents and/or cleaning agents; water, emollients, surfactants, fragrances, preservatives, chelating agents, pH buffers, or combinations thereof as are well known to those skilled in the art. Further, the wetting agent may also contain lotions, medicaments, and/or other antimicrobials.

Relative to the weight of the dry surface, the wipe may desirably contain from about 8.5 percent to about 600 percent of the wetting composition by weight, more desirably from about 50 percent to about 500 percent of the wetting composition by weight, even more desirably from about 70 percent to about 400 percent of the wetting composition by weight.

The wetting composition may be applied to the fibrous material by any known process. Suitable processes for applying the wetting composition include, but are not limited to printing, spraying, electrostatic spraying, the use of metered press rolls or impregnating. The amount of wetting composition may be metered and distributed uniformly onto the fibrous material or may be non-uniformly distributed onto the fibrous material.

For ease of application, the wetting composition may be applied to the fibrous material in combination with a solvent, as a solution or mixture. A variety of solvents may be used, including, for example, water, methanol, ethanol, acetone, or the like. The amount of wetting composition in the solvent may vary, depending on a variety of factors, including the identity and physical characteristics of the fibrous material to which the wetting composition is being applied. The mixture or solution of the wetting composition may contain up to about 50 percent by weight of wetting composition solids. The wetting composition or mixture may contain from about 8.5 to 30 percent by weight of wetting composition solids. Even more desirably, the wetting composition or mixture may contain about 12 to 25 percent by weight wetting composition solids.

Once the wetting composition is applied to the fibrous material, drying, if necessary, may be achieved by any conventional means. Once dry, the nonwoven material may exhibit improved tensile strength when compared to the tensile strength of the untreated wet-laid or dry-laid fibrous material.

The finished wipes may be individually packaged, desirably in a folded condition, in a moisture proof envelope or packaged in containers holding any desired number of sheets in a water-tight package with a wetting composition applied to the wipe. Some example processes which can be used to manufacture folded wipes are described in U.S. Pat. Nos. 5,540,332 and 6,855,748, which are incorporated by reference herein to the extent they are consistent herewith. The finished wipes may also be packaged as a roll of separable sheets in a moisture-proof container holding any desired number of sheets on the roll with a wetting composition applied to the wipes. The roll can be coreless and either hollow or solid. Coreless rolls, including rolls with a hollow center or without a solid center, can be produced with known coreless roll winders, including those of SRP Industry, Inc. (San Jose, Calif.); Shimizu Manufacturing (Japan), and the devices disclosed in U.S. Pat. No. 4,667,885. The U.S. Pat. No. 6,651,924 also provides examples of a process for producing coreless rolls of wipes.

### Dispensing Agents

In another aspect, the sanitizers of the present disclosure may be used in combination with a product, such as a personal care product. More particularly, the sanitizer may be incorporated into or onto a surface, such as a wipe surface, an absorbent surface, a fabric or cloth surface, or a tissue surface, among others. For example, the compositions may be incorporated into personal care products, such as wipes, absorbent articles, bath tissues, cloths, and the like. The sanitizer may be incorporated into wipes such as wipes, hand wipes, face wipes, cosmetic wipes, and the like, or absorbent articles, such as diapers, training pants, adult incontinence products, feminine hygiene products, and the like, and combinations thereof. In one embodiment, the sanitizer is a liquid composition that may be used in combination with a wipe surface to form a wipe or may be a wetting composition for use in combination with a dispersible wipe. In another embodiment, the sanitizer can be used in combination with a wipe surface, which is packaged together with one or more absorbent articles, such as diapers.

In some embodiments, the composition is applied directly to the surface. In some embodiments, the composition is placed on or in an applicator or dispenser, which then applies the composition to the surface. In some embodiments, the applicator or dispenser is a cloth, a wipe, a sponge, a mop, a squirt bottle, a spray bottle, a pump bottle, a tube, an automatic induction hand sterilizer, a bottle or container comprising a dropper, bottle or container comprising a pour spout, or a canister. In some embodiments, the spray bottle is a continuous spray bottle. In some embodiments, the spray bottle is a propellant-free continuous spray bottle. In some embodiments, the continuous spray bottle is a flairosol sprayer. In some embodiments, the spray bottle is an aerosol sprayer. In some embodiments, the spray bottle is a mist spray bottle.

### III. Methods of Use

In an aspect provided herein, is a method of sanitizing or disinfecting an inanimate surface, comprising applying to the surface a sanitizing composition for an inanimate surface, comprising: an ionic liquid having a cationic component and an anionic component;
wherein the composition comprises about 1% to about 10% by weight of the ionic liquid.

In an aspect provided herein, is a method of sanitizing or disinfecting a surface, comprising applying to the surface a wipe, comprising a surface retaining a releasable sanitizing composition for an inanimate surface, comprising:
an ionic liquid having a cationic component and an anionic component;
wherein the composition comprises about 1% to about 10% by weight of the ionic liquid.

In an aspect provided herein, is a method for inhibiting or decreasing microbial growth on a surface, comprising: applying to the surface a wipe, comprising a surface retaining a releasable sanitizing composition for an inanimate surface, comprising:
an ionic liquid having a cationic component and an anionic component;
wherein the composition comprises about 1% to about 10% by weight of the ionic liquid.

In an aspect provided herein, is a method for inhibiting or decreasing microbial growth on an inanimate surface, comprising applying to the surface a wipe, comprising a surface retaining a releasable sanitizing composition for an inanimate surface, comprising:
an ionic liquid having a cationic component and an anionic component;
wherein the composition comprises about 1% to about 10% by weight of the ionic liquid.

In some embodiments, the composition is rinseless. In some embodiments, at least part of the composition evaporates off of the surface. In some embodiments, the composition remains on the surface for at least about two hours. In some embodiments, the composition remains on the surface for at least about four hours. In some embodiments, the composition remains on the surface until cleaned, wiped, or rinsed off. In some embodiments, the ionic liquid is non-irritating to the skin.

### Wetting Agents

In some embodiments, the disinfectant compositions disclosed herein are formulated as wetting agents (e.g., for wipes).

In an aspect, provided herein is a sanitizing composition for an inanimate surface, comprising: an ionic liquid having a cationic component and an anionic component;
wherein the composition comprises about 1% to about 10% by weight of the ionic liquid.

In some embodiments, the ionic liquid is a deep eutectant solvent. In some embodiments, the ionic liquid is non-irritating to the skin. In some embodiments, at least one of the anionic component and cationic component is irritating to the skin when applied in the absence of the other component.

In some embodiments, the anionic component is bistriflimide, a geranate, an oleate, a hexanoate, dodecyldimethyl ammonia propane sulfonate, N-lauryl sarcosinate, or a geraniolate.

In some embodiments, the cationic component is benzyl pyridinium, benzyl dimethyl dodecyl ammonium, a choline cation, phosphonium, benzethonium, or a phosphonium.

In some embodiments, the phosphonium is a tetraalkyl phosphonium of structural Formula (I): PR₄, wherein R is a substituted or unsubstituted alkyl group.

In some embodiments, the cationic component is a choline cation.

In some embodiments, the anionic component is a geranate anion

In some embodiments, the cationic component and the anionic component are in a molar ratio ranging from about 1:1 to about 1:4 (cationic component to anionic component). In some embodiments, the cationic component and the anionic component are in a molar ratio ranging from about 1:1 to about 1:2 (cationic component to anionic component).

In some embodiments, the cationic component and the anionic component are in a molar ratio of about 1:2 (cationic component to anionic component).

In some embodiments, the composition comprises about 1% to about 5% by weight of the ionic liquid.

In some embodiments, the composition comprises about 1% to about 10% by weight of the ionic liquid. In some embodiments, the composition comprises about 1% to about 3% by weight of the ionic liquid. In some embodiments, the composition comprises up to about 10% by weight of the ionic liquid (CG-101). In some embodiments, the composition comprises at least about 1% by weight of the ionic liquid (CG-101). In some embodiments, the composition comprises about 2.0% by weight of the ionic liquid (CG-101). In some embodiments, the composition comprises about 1.0, about 2.0, about 3.0, about 4.0, about 5.0, about 6.0, about 7.0, about 8.0, about 9.0, or about 10% by weight of the ionic liquid (CG-101).

In some embodiments, the composition further comprises at least one additive or carrier.

In some embodiments, the composition further comprises a pH adjuster, skin conditioner, colorants, fragrance, viscosity enhancing agent, humectant, emollient, antioxidant, preservative, solvent, co-solvent, chelant, solubilizer, coupling agent, corrosion inhibitor, rheology modifier, UV stabilizer, optical brightener, active ingredient indicators, or combinations thereof.

In some embodiments, the fragrance is D-limonene.

In some embodiments, the fragrance is present in the composition an amount of from about 0.2% to about 1.0% by weight. In some embodiments, the fragrance is present in the composition an amount of from about 0.4% to about 0.6% by weight. In some embodiments, the fragrance is present in the composition an amount of about 0.6% by weight. In some embodiments, the fragrance is present in the composition an amount of about 0.4% by weight.

In some embodiments, the viscosity enhancing agent is hydroxypropyl cellulose.

In some embodiments, the viscosity enhancing agent is present in the composition in an amount of from about 0.005% to about 0.4% by weight. In some embodiments, the viscosity enhancing agent is present in the composition in an amount of up to about 0.4% by weight. In some embodiments, the viscosity enhancing agent is present in the composition in an amount of at least about 0.005% by weight. In some embodiments, the viscosity enhancing agent is present in the composition in an amount of about about 0.006, about 0.007, about 0.008, about 0.009, about 0.01, about 0.02, about 0.03, about 0.04, about 0.05, about 0.06, about 0.07, about 0.08, about 0.09, 0.1, about 0.2, about 0.3, about 0.4, or about by weight. In some embodiments, the viscosity enhancing agent is present in the composition in an amount of about 0.5% by weight.

In some embodiments, the humectant is glycerin.

In some embodiments, the humectant is present in the composition an amount of from about 0.5% to about 5% by weight.

In some embodiments, the humectant is present in the composition an amount of from about 1% to about 2% by weight.

In some embodiments, the solvent is a terpene alcohol, terpene ester, terpene ether, terpene aldehyde, or combinations thereof.

In some embodiments, the solvent is pine oil, lemon oil, limonene, pinene, cymene, myrcene, fenchone, borneol, nopol, cineole, ionone, or combinations thereof.

In some embodiments, the composition further comprises emollients.

In some embodiments, the composition further comprises hydroxypropyl cellulose, hydroxypropyl methyl cellulose, methyl cellulose, ethylene glycol monopropyl ether, ethylene glycol monobutyl ether, ethylene glycol monohexyl ether, ethylene clycol monohexyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, propylene glycol methyl ether, propylene glycol methyl ether acetate, propylene glycol n-butyl ether, dipropylene glycol n-butyl ether, dipropylene glycol methyl ether, dipropylene glycol methyl ether acetate, propylene glycol n-propyl ether, dipropylene glycol n-propyl ether, and tripropylene glycol methyl ether.

In some embodiments, the hydroxypropyl cellulose is present in the composition an amount of from about 0.005% to about 0.400% by weight.

In some embodiments, the hydroxypropyl cellulose is present in the composition an amount of about 0.01% by weight

In some embodiments, the pH adjustor is triethanolamine, diethanolamine, monoethanolamine, sodium hydroxide, sodium carbonate, potassium hydroxide, potassium carbonate, calcium carbonate, citric acid, acetic acid, hydrochloric acid, sulfamic acid, sulfuric acid, or combinations thereof.

In some embodiments, the composition has a pH of from about 6.0 to about 8.0.

In some embodiments, the composition further comprises water.

In some embodiments, the composition further comprises a C₁-C₈ alcohol. In some embodiments, the alcohol is ethanol, iso-propyl alcohol, n-propyl alcohol, butanol, pentanol, or combinations thereof. In some embodiments, the alcohol is ethanol, iso-propyl alcohol, or a combination thereof. In some embodiments, the alcohol is ethanol. In some embodiments, the alcohol is present in the composition in an amount of from about 45% to about 70% by weight. In some embodiments, the ethanol is present in the composition in an amount of about 50% to about 70% by weight. In some embodiments, the ethanol is present in the composition in an amount of about 60% by weight. In some embodiments, the alcohol is iso-propyl alcohol. In some embodiments, the iso-propyl alcohol is present in the composition in an amount of from about 1% to about 10% by weight. In some embodiments, the iso-propyl alcohol is present in the composition in an amount of about 4% to about 6% by weight. In some embodiments, the iso-propyl alcohol is present in the composition in an amount of about 5% by weight. In some embodiments, the alcohol is a mixture of ethanol and iso-propyl alcohol.

In some embodiments, the composition is placed on or in an applicator or dispenser. In some embodiments, the applicator or dispenser is a cloth, a wipe, a sponge, a mop, a squirt bottle, a spray bottle, a pump bottle, a tube, an automatic induction hand sterilizer, a bottle or container comprising a dropper, bottle or container comprising a pour spout, or a canister. In some embodiments, the spray bottle is a continuous spray bottle, a propellant-free continuous spray bottle, a flairosol sprayer, an aerosol sprayer, or a mist spray bottle.

In some embodiments, the composition is formulated for administration to a surface. In some embodiments, the composition is formulated for application to a hard surface. In some embodiments, the composition is formulated for application to a non-porous surface. In some embodiments, the composition is formulated for application to a porous surface.

In some embodiments, the composition is rinseless.

In some embodiments, the composition further comprises a sporicide and/or additional antimicrobial agent. In some embodiments, the sporicide is hydrogen peroxide.

In some embodiments, the composition is formulated to remain on a surface for at least about two hours. In some embodiments, the composition is formulated to remain on a surface for at least about four hours. In some embodiments, the composition is formulated to remain on a surface for at least up to about 24 hours. In some embodiments, the composition is formulated to remain on a surface until rinsed or washed off. In some embodiments, the composition is rinseless.

In some embodiments, the ionic liquid comprises the choline cation and geranic acid anion in a molar ratio of 1:1 or 1:2 of choline cation to geranic acid anion. In some embodiments, the ionic liquid comprises the choline cation and geranic acid anion in a molar ratio in a range of 1:1 to 1:4 of choline cation to geranic acid anion. In some embodiments, the ionic liquid comprises the choline cation and geranic acid anion in a molar ratio of 1:1, 1:2, 1:3, or 1:4 of choline cation to geranic acid anion. In some embodiments, the composition provides an increased antimicrobial action compared to an antimicrobial action of choline or an antimicrobial action of geranic acid. In some embodiments, the increased antimicrobial action is a 10 fold less concentration of the composition required for complete killing of a microbe relative to a concentration of choline or a concentration of geranic acid required for complete killing of the microbe. In some embodiments, the ionic liquid comprises a concentration of about 0.1% to 99% of the composition, and the pharmaceutically acceptable solvent comprises a concentration of about 1% to about 99.9% of the composition.

In some embodiments, the composition is formulated as a liquid, gel, cream, foam, lotion, cream, wetting composition, or a spray. In some embodiments, the composition is formulated for topical administration. In some embodiments, the composition is formulated as a gel.

### Microbes

In some embodiments, the compositions of the present disclosure slow the spread of gram-positive and/or gram-negative bacteria, fungi, mold, viruses, protozoans, parasites, and other microbes. In some embodiments, the compositions of the present disclosure prevent or slow contamination of a surface with gram-positive and/or gram-negative bacteria, fungi, mold, viruses, protozoans, parasites, and other microbes. In some embodiments, the microbial growth is growth of a virus, bacterium, fungus, mold, protozoan, parasite, or combinations thereof.

In some embodiments, the bacterium is a gram-negative bacterium. In some embodiments, the gram-negative bacterium is an Escherichia, Salmonella, Klebsiella bacterium, or any combination thereof. In some embodiments, the Escherichia bacterium is E. coli.

In some embodiments, the gram-positive bacterium is a Staphylococcus or Streptococcus bacterium. In some embodiments, the Staphylococcus bacterium is S. aureus. In some embodiments, the Staphylococcus bacterium is methicillin-resistant S. aureus (MRSA). In some embodiments, the bacterium is S. enterica, S. pyogenes, K. pneumoniae, or any combination thereof.

In some embodiments, the virus is in Coronaviridae family. In some embodiments, the virus is in Orthocoronaviridae subfamily. In some embodiments, the virus is a Betacoronavirus (β-CoV). In some embodiments, the virus is a Sarbecovirus . In some embodiments, the virus is an Ebolavirus, Coronavirus, Rotavirus, Alphainfluenzavirus, Betainfluenzavirus, Deltainfluenzavirus, and/or Gammainfluenzavirus

In some embodiments, the virus is a human virus. In some embodiments, the virus is severe acute respiratory syndrome coronavirus 2 (SARS-CoV-2). In some embodiments, the virus is human severe acute respiratory syndrome coronavirus 2 (SARS-CoV-2). In some embodiments, the virus is Influenza A, B, and/or C. In some embodiments, the virus is Influenza A2 virus.

### IV. Non-Limiting Embodiments

1. A disinfectant composition for an inanimate surface, comprising: an ionic liquid having a cationic component and an anionic component; wherein the composition comprises about 1% to about 10% by weight of the ionic liquid.
2. The disinfectant composition of Embodiment 1, wherein the ionic liquid is a deep eutectant solvent.
3. The disinfectant composition of Embodiment 1 or 2, wherein at least one of the anionic component and cationic component is irritating to the skin when applied in the absence of the other component.
4. The disinfectant composition of any one of Embodiments 1-3, wherein the anionic component is bistriflimide, a geranate, an oleate, a hexanoate, dodecyldimethyl ammonia propane sulfonate, N-lauryl sarcosinate, or a geraniolate.
5. The disinfectant composition of any one of Embodiments 1-4, wherein the cationic component is benzyl pyridinium, benzyl dimethyl dodecyl ammonium, a choline cation, phosphonium, benzethonium, or a phosphonium.
6. The disinfectant composition of Embodiment 5, wherein the phosphonium is a tetraalkyl phosphonium of structural Formula (I): PR₄, wherein R is a substituted or unsubstituted alkyl group.
7. The disinfectant composition of any one of Embodiments 1-6, wherein the cationic component is a choline cation.
8. The disinfectant composition of any one of Embodiments 1-7, wherein the anionic component is a geranate anion
9. The disinfectant composition of any one of Embodiments 1-8, wherein the cationic component and the anionic component are in a molar ratio ranging from about 1:1 to about 1:2 (cationic component to anionic component).
10. The disinfectant composition of any one of Embodiments 1-9, wherein the cationic component and the anionic component are in a molar ratio of about 1:2 (cationic component to anionic component).
11. The disinfectant composition of any one of Embodiments 1-10, wherein the composition comprises about 1% to about 5% by weight of the ionic liquid.
12. The disinfectant composition of any one of Embodiments 1-11, wherein the composition comprises about 1% to about 3% by weight of the ionic liquid.
13. The disinfectant composition of any one of Embodiments 1-12, wherein the composition further comprises at least one additive or carrier.
14. The disinfectant composition of any one of Embodiments 1-13, wherein the composition further comprises a pH adjuster, skin conditioner, colorants, fragrance, viscosity enhancing agent, antioxidant, preservative, solvent, co-solvent, a surfactant, a chelant, solubilizer, coupling agent, corrosion inhibitor, rheology modifier, UV stabilizer, optical brightener, active ingredient indicators, or combinations thereof.
15. The disinfectant composition of Embodiment 14, wherein the fragrance is D-limonene.
16. The disinfectant composition of Embodiment 13 or 14, wherein the fragrance is present in the composition an amount of from about 0.2% to about 1.0% by weight.
17. The disinfectant composition of any one of Embodiments 13-16, wherein the fragrance is present in the composition an amount of from about 0.4% to about 0.6% by weight.
18. The disinfectant composition of any one of Embodiments 13-17, wherein the fragrance is present in the composition an amount of about 0.4% by weight
19. The disinfectant composition of any one of Embodiments 13-17, wherein the viscosity enhancing agent is hydroxypropyl cellulose.
20. The disinfectant composition of any one of Embodiments 13-17, wherein the viscosity enhancing agent is present in the composition in an amount of from about 0.005% to about 0.4% by weight.
21. The disinfectant composition of any one of Embodiments 13-20, wherein the viscosity enhancing agent is present in the composition in an amount of from about 0.005% to about 0.02% by weight.
22. The disinfectant composition of any one of Embodiments 13-21, wherein the viscosity enhancing agent is present in the composition in an amount of about 0.5% by weight.
23. The disinfectant composition of any one of Embodiments 13-22, wherein the composition further comprises a poloxamer.
24. The disinfectant composition of any one of Embodiments 13-23, wherein the poloxamer is present in the composition an amount of from about 2% to about 10% by weight.
25. The disinfectant composition of any one of Embodiments 13-24, wherein the poloxamer is present in the composition an amount of from about 3% to about 10% by weight.
26. The disinfectant composition of any one of Embodiments 13-25, wherein the poloxamer is present in the composition an amount of from about 4% to about 10% by weight.
27. The disinfectant composition of any one of Embodiments 13-26, wherein the poloxamer is present in the composition an amount of from about 5% to about 10% by weight.
28. The disinfectant composition of any one of Embodiments 1-27, wherein the composition further comprises a viscosity enhancing agent.
29. The disinfectant composition of Embodiment 28, wherein the viscosity enhancing agent is selected from the group consisting of hydroxypropyl cellulose, hydroxypropyl methyl cellulose, methyl cellulose, ethylene glycol monopropyl ether, ethylene glycol monobutyl ether, ethylene glycol monohexyl ether, ethylene clycol monohexyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, propylene glycol methyl ether, propylene glycol methyl ether acetate, propylene glycol n-butyl ether, dipropylene glycol n-butyl ether, dipropylene glycol methyl ether, dipropylene glycol methyl ether acetate, propylene glycol n-propyl ether, dipropylene glycol n-propyl ether, and tripropylene glycol methyl ether.
30. The disinfectant composition of Embodiment 29, wherein the hydroxypropyl cellulose is present in the composition an amount of from about 0.005% to about 0.400% by weight.
31. The disinfectant composition of Embodiment 29 or 30, wherein the hydroxypropyl cellulose is present in the composition an amount of about 0.01% by weight
32. The composition of any one of Embodiments 13-31, wherein the pH adjustor is triethanolamine, diethanolamine, monoethanolamine, sodium hydroxide, sodium carbonate, potassium hydroxide, potassium carbonate, calcium carbonate, citric acid, acetic acid, hydrochloric acid, sulfamic acid, sulfuric acid, or combinations thereof.
33. The disinfectant composition of any one of Embodiments 1-32, wherein the composition has a pH of from about 6.0 to about 8.0.
34. The disinfectant composition of any one of Embodiments 1-33, wherein the composition further comprises water.
35. The disinfectant composition of any one of Embodiments 1-34, wherein the composition further comprises a CI-Cs alcohol.
36. The disinfectant composition of Embodiment 35, wherein the alcohol is ethanol, iso-propyl alcohol, n-propyl alcohol, butanol, pentanol, or combinations thereof.
37. The disinfectant composition of Embodiment 35 or 36, wherein the alcohol is ethanol, iso-propyl alcohol, or a combination thereof.
38. The disinfectant composition of any one of Embodiments 35-37, wherein the alcohol is ethanol.
39. The disinfectant composition of Embodiment 38, wherein the alcohol is present in the composition in an amount of from about 45% to about 70% by weight.
40. The disinfectant composition of any one of Embodiments 36-39, wherein the ethanol is present in the composition in an amount of about 50% to about 70% by weight.
41. The disinfectant composition of any one of Embodiments 36-40, wherein the ethanol is present in the composition in an amount of about 60% by weight.
42. The disinfectant composition of any one of Embodiments 36-39, wherein the alcohol is iso-propyl alcohol.
43. The disinfectant composition of any one of Embodiments 36-40, wherein the iso-propyl alcohol is present in the composition in an amount of from about 1% to about 10% by weight.
44. The disinfectant composition of any one of Embodiments 36-41, wherein the iso-propyl alcohol is present in the composition in an amount of about 4% to about 6% by weight.
45. The disinfectant composition of any one of Embodiments 36-42, wherein the iso-propyl alcohol is present in the composition in an amount of about 5% by weight.
46. The disinfectant composition of any one of Embodiments 1-45, the composition is placed on or in an applicator or dispenser.
47. The disinfectant composition of Embodiment 46, wherein the applicator or dispenser is a cloth, a wipe, a sponge, a mop, a squirt bottle, a spray bottle, a pump bottle, a tube, an automatic induction hand sterilizer, a bottle or container comprising a dropper, bottle or container comprising a pour spout, or a canister.
48. The disinfectant composition of Embodiment 47, wherein the spray bottle is a continuous spray bottle, a propellant-free continuous spray bottle, a flairosol sprayer, an aerosol sprayer, or a mist spray bottle.
49. The disinfectant composition of any one of Embodiments 1-48, wherein the composition is non-irritating to skin.
50. The disinfectant composition of any one of Embodiments 1-49, wherein the composition is formulated for application to a hard surface.
51. The disinfectant composition of any one of Embodiments 1-50, wherein the composition is formulated for application to a non-porous surface.
52. The disinfectant composition of any one of Embodiments 1-50, wherein the composition is formulated for application to a porous surface.
53. The disinfectant composition of any one of Embodiments 1-52, wherein the composition is rinseless.
54. The disinfectant composition of any one of Embodiments 1-53, wherein the composition further comprises a sporicide and/or additional antimicrobial agent.
55. The disinfectant composition of Embodiment 54, wherein the sporicide is hydrogen peroxide.
56. The disinfectant composition of any one of Embodiments 1-55, wherein the composition is formulated to remain on a surface for at least about two hours.
57. The disinfectant composition of any one of Embodiments 1-56, wherein the composition is formulated to remain on a surface for at least about four hours.
58. The disinfectant composition of any one of Embodiments 1-57, wherein the composition is formulated to remain on a surface for at least up to about 24 hours
59. The disinfectant composition of any one of Embodiments 1-58, wherein the composition is formulated to remain on a surface until rinsed or washed off.
60. The method of any one of Embodiments 1-59, wherein the composition is rinseless.
61. A kit comprising the disinfectant composition of any one of Embodiments 1-60 and a dispenser or applicator.
62. A wipe, comprising a surface retaining a releasable disinfectant composition of any one of Embodiments 1-61.
63. The wipe of Embodiment 62, wherein the surface retaining a releasable disinfectant composition is a textile.
64. The wipe of Embodiment 63, wherein the textile is cloth, a wipe, a sponge, or a mop.
65. A method of sanitizing or disinfecting a surface, comprising applying to the surface the composition, kit, or wipe of any one of Embodiments 1-64.
66. A method for inhibiting or decreasing microbial growth on a surface, comprising applying to the surface the composition, kit, or wipe of any one of Embodiments 1-64.
67. The method of Embodiment 64 or 65, wherein the microbial growth is growth of a virus, bacterium, fungus, mold, protozoan, parasite, or combinations thereof.
68. The method of Embodiment 67, wherein the bacterium is a gram-negative bacterium.
69. The method of Embodiment 68, wherein the gram-negative bacterium is an Escherichia, Salmonella, Klebsiella bacterium, or any combination thereof.
70. The method of Embodiment 69, wherein the Escherichia bacterium is E. coli.
71. The method of Embodiment 67, wherein the bacterium is a gram-positive bacterium.
72. The method of Embodiment 71, wherein the gram-positive bacterium is a Staphylococcus or Streptococcus bacterium.
73. The method of Embodiment 72, wherein the Staphylococcus bacterium is methicillin-resistant S. aureus (MRSA).
74. The method of any one of Embodiments 66-73, wherein the virus is an Ebolavirus, Coronavirus, Rotavirus, Alphainfluenzavirus, Betainfluenzavirus, Deltainfluenzavirus, Gammainfluenzavirus, or any combination thereof.
75. The method of any one of Embodiments 66-74, wherein the virus is a Coronavirus.
76. The method of embodiment 75, wherein the Coronavirus is severe acute respiratory syndrome coronavirus 2 (SARS-CoV-2).
77. The method of any one of Embodiments 66-76, wherein the virus is a human virus.

### EXAMPLE 1. DISINFECTANT FORMULATIONS WITH CG-101 (CAGE 1:2)

| | Formulation |
|---|---|
| Ingredient | (% w/w) |
| CG-101 | 1-10 |
| Ethyl Alcohol | 45-70 |
| Isopropanol | 1-10 |
| Hydroxypropyl cellulose | 0.005-0.400 |
| D-Limonene | 0.2-1.0 |
| Water | q.s. |

In one embodiment, the composition of the CAGE-based disinfectant formulation is the formulation shown in Table 1B.

TABLE 1B

| | Formulation |
|---|---|
| Ingredient | (% w/w) |
| CG-101 | 1-10 |
| Ethyl Alcohol | 45-70 |
| Isopropanol | 1-10 |
| Propylene glycol | 1-2 |
| Hydroxypropyl cellulose | 0.005-0.400 |
| D-Limonene | 0.2-1.0 |
| Water | q.s. |

In one embodiment, the composition of the CAGE-based disinfectant formulation is the formulation shown in Table 1C.

TABLE 1C

| | Formulation |
|---|---|
| Ingredient | (% w/w) |
| CG-101 | 2 |
| Ethyl Alcohol | 60 |
| Isopropanol | 5 |
| Hydroxypropyl cellulose | 0.01 |
| D-Limonene | 0.4-0.5 |
| Water | q.s. |

In one embodiment, the composition of the CAGE-based disinfectant formulation is the

formulation shown in Table 1D.

TABLE 1D

| | Formulation |
|---|---|
| Ingredient | (% w/w) |
| CG-101 | 2 |
| Ethyl Alcohol | 60 |
| Isopropanol | 5 |
| Propylene glycol | 2 |
| Hydroxypropyl cellulose | 0.01 |
| D-Limonene | 0.4-0.5 |
| Water | q.s. |

In one embodiment, the composition of the CAGE-based disinfectant formulation is the formulation shown in Table 1E.

TABLE 1E

| | Formulation |
|---|---|
| Ingredient | (% w/w) |
| CG-101 | 1-5 |
| Poloxamer 407 | 5-10 |
| Hydroxypropyl cellulose | 0.01 |
| (optional) | |
| D-Limonene (optional) | 0.4-0.5 |
| Water | q.s. |

In one embodiment, the composition of the CAGE-based disinfectant formulation is the formulation shown in Table 1F.

TABLE 1F

| | Formulation |
|---|---|
| Ingredient | (% w/w) |
| CG-101 | 2 |
| Poloxamer 407 | 5-10 |
| Hydroxypropyl cellulose | 0.01 |
| (optional) | |
| D-Limonene (optional) | 0.4-0.5 |
| Water | q.s. |

In one embodiment, the composition of the CAGE-based disinfectant formulation is the formulation shown in Table 1G.

TABLE 1G

| | Formulation |
|---|---|
| Ingredient | (% w/w) |
| CG-101 | 3 |
| Poloxamer 407 | 5-10 |
| Hydroxypropyl cellulose | 0.01 |
| (optional) | |
| D-Limonene (optional) | 0.4-0.5 |
| Water | q.s. |

In one embodiment, the composition of the CAGE-based disinfectant formulation is the formulation shown in Table 1H.

TABLE 1H

| | Formulation |
|---|---|
| Ingredient | (% w/w) |
| CG-101 | 5 |
| Poloxamer 407 | 5-10 |
| Hydroxypropyl cellulose | 0.01 |
| (optional) | |
| D-Limonene (optional) | 0.4-0.5 |
| Water | q.s. |

One-step lab scale preparation of CG-101 (CAGE_{1:2}). Choline geranate (CAGE_{1:2}) was synthesized as described previously. Briefly, the cation, choline bicarbonate and geranic acid, anion was mixed at a 1:2 ratio to prepare IL/deep eutectic mixture following salt metathesis reaction. Geranic acid (3.696 mol) was weighed in a stainless-steel vessel equipped with a stirrer and placed into a water bath. Choline bicarbonate 80% solution (1.848 mol) was added dropwise to the vessel. The mixture was reacted for 8 h at 27° C. The water content of the resulting IL/deep eutectic mixture was measured using Karl Fischer (KF) titration as an in-process parameter

### EXAMPLE 2. SELF-SANITIZING ACTIVITY STUDY OF DISINFECTANT

Method (modified EPA Protocol #01-1A: “Protocol for Residual Self-Sanitizing Activity of Dried Chemical Residues on Hard, Non-Porous Surfaces.”

### Brief Description:

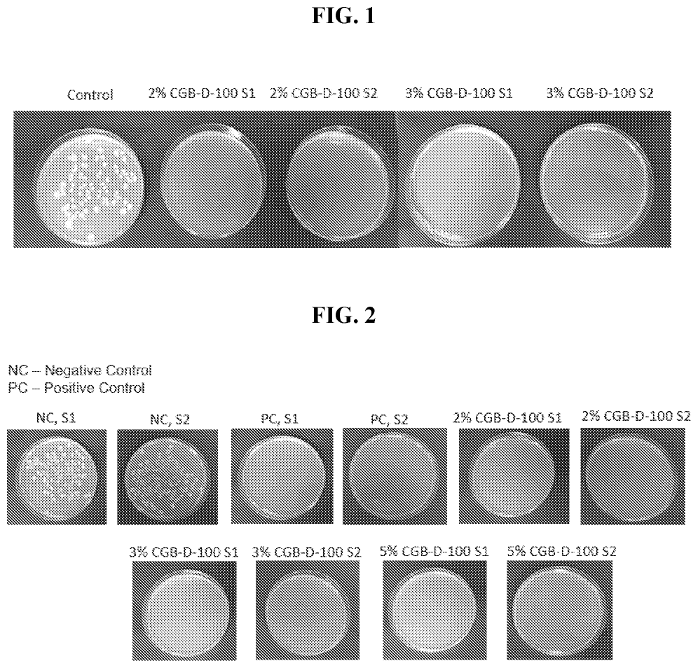

Each pre-cleaned glass surface was inoculated with 10 μL of E. coli in concentration of 5.5×106 CFU/mL. After 30 min of drying at 37° C. Test Product was applied on each glass surface (8 sprays) and left to dry for 3 hrs. Re-inoculation with 10 μL of E. coli suspension was performed on each surface 5 more times where first 4 re-inoculations happened on Day 1 and the last re-inoculation (#5) happened on the next day, after 24 hrs, of Test Product application. At the last re-inoculation, after 5 min of a contact time each surface was transferred into 30 mL of neutralizing broth, sonicated for 20 sec and was shaken for 3-4 min at 250 rpm. After all materials were submerged in neutralization broth each sample was plated on TS agar plate. Then, samples were transferred into the incubator set at 37° C. As a control, cleaned glass surface was used. FIG. 1 shows the self-sanitizing activity of the disinfectant.

### EXAMPLE 3. SELF-SANITIZING ACTIVITY STUDY OF DISINFECTANT

According to EPA Protocol #01-1A: “Protocol for Residual Self-Sanitizing Activity of Dried Chemical Residues on Hard, Non-Porous Surfaces.”

### Brief Description:

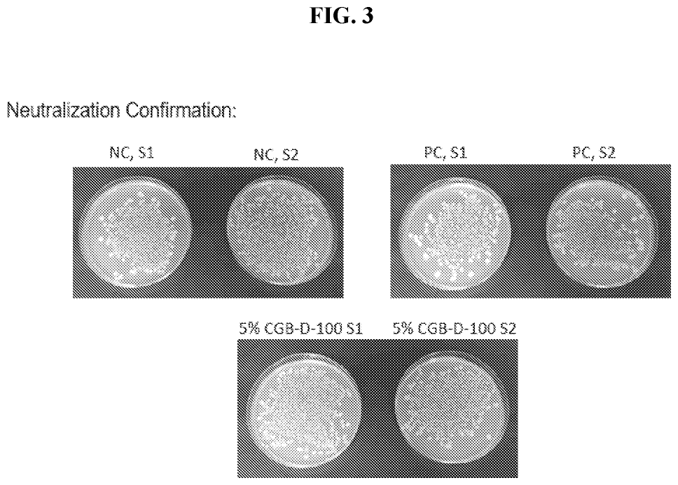

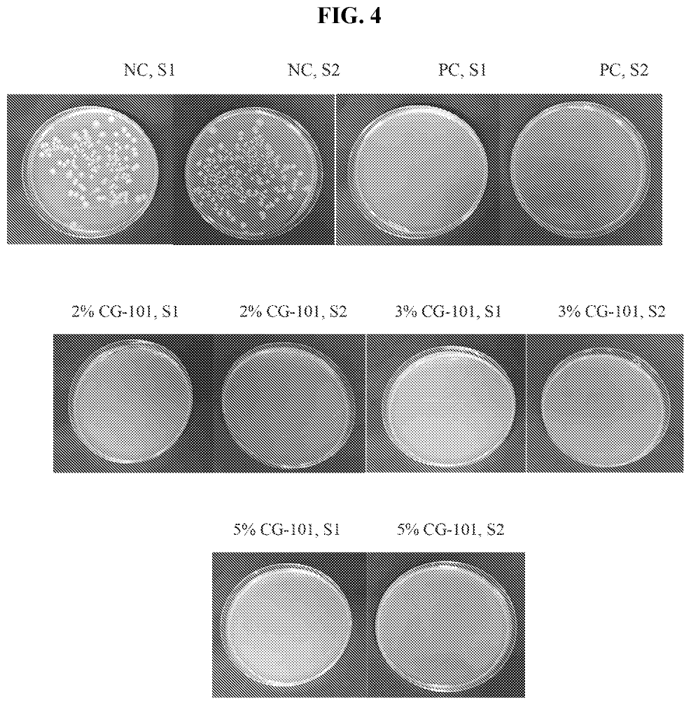

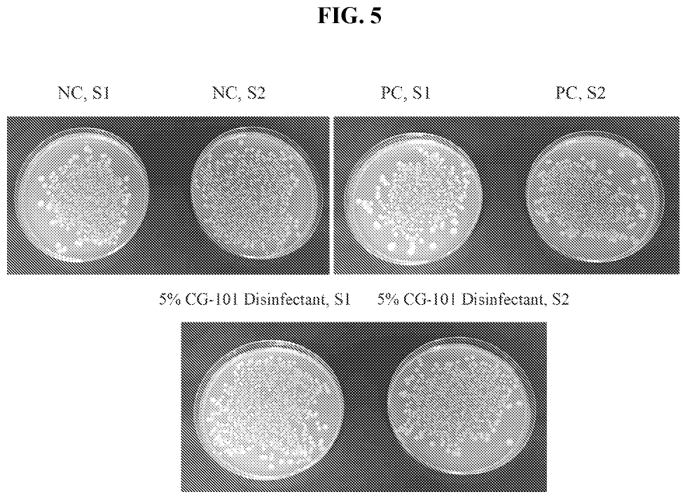

Each pre-cleaned glass surface was inoculated with 10 μL of E. coli in concentration of 4.4×10⁶ CFU/mL. After 30 min of drying at 37° C. incubator Test Product, Negative Control, and Positive Control were applied on each glass surface (8 sprays) and left to dry for 3 hrs. Duplicates were prepared for each material. Six “wearing cycles” (dry and moist) were performed on each surface. Five re-inoculations with E. coli suspension were performed over the 24 hours period. After 24 hrs of the test products application the last inoculation was performed. After 5 min of a contact time each surface was transferred into 30 mL of neutralizing broth, sonicated for 20 sec and was shaken for 3-4 min at 250 rpm. Then, each suspension was plated onto TS agar plates, allowed to dry and were transferred into the incubator set at 37° C. for 48 h. As a negative control, sterile saline solution was used. As a positive control, Microban® 24 was used (see FIG. 2-FIG. 3).

### EXAMPLE 4. EVALUATION OF RESIDUAL SELF-SANITIZING ACTIVITY OF CGB-D-100 ON HARD, NON-POROUS SURFACE

### Purpose:

The purpose of this study is to test residual self-sanitizing activity of CGB-D-100 disinfectant per EPA protocol 01-1A, “Residual Self-Sanitizing Activity of Dried Chemical Residues on Hard, Non-Porous Surfaces.”

### Scope:

The scope of this study is to evaluate residual self-sanitizing activity of CGB-D-100 disinfectant with three different concentrations of CG-101, and to compare it to a marketed disinfectant (Microban® 24). Glass surface (microscope slides) will be used as a non-porous surface. Sterile saline solution will be used as a negative control and Microban® 24 will be used as the positive control. The method will simulate contact and touches by incorporating wear or wiping of the test surface as well as reinoculations of the test and control surfaces over 24 hours. The EPA protocol requires the use of an automated abrasion tester to simulate wear from wiping the surface. For the purposes of this protocol, abrasion or wear were be performed manually using cotton wipes.

### Procedure:

First, the glass slides will be washed with a non-medical soap and water followed by cleaning with 70% alcohol and allowed to air dry. The glass slides will then be decontaminated by immersing them in absolute ethanol, wiping and will be allowed to air dry. All decontaminated glass surfaces will be transferred to individual plastic petri dishes lined with 1-2 layers of Whatman No. 2 paper or similar. Ten (10) microliter aliquot of the microbial suspension will be applied to the test surfaces, spread to within ⅛ inch of the edge with a bent inoculating needle, and dried uncovered at 37±2° C. for 30-35 minutes, or until visibly dry.

Test product, negative control, and positive control will be applied to replicate test surfaces according to the product's Directions for Use or until surface is completely wet. The surfaces will be allowed to dry at ambient conditions for at least 3 hours or until they are completely dry. The temperature and humidity in the lab will be recorded.

Wear cycles were performed manually for a surface contact time of approximately 4-5 seconds per cycle. One pass shall provide a contact time with the surfaces of approximately 2 seconds. One cycle equals one pass to the left and a return pass to the right. The treated surfaces will undergo no less than 6 wear cycles (3 dry and 3 wet cycles in alternating manner) over a period of 24 hours at room temperature. For the wet cycle, the cloth wipe was sprayed with sterile distilled water using a sprayer, from a distance of 75±1 cm for no more than one second. The wet cloth was used for wet abrasion immediately after spraying. Re-inoculations were performed at least 15 minutes after every wear cycle. After each re-inoculation at least a 30-minute drying time at ambient temperature was allowed.

The wear and re-inoculating cycles were performed as described below.
a) Inoculation with test organism
b) Apply test product
c) Wear cycle* with dry cloth (wear # 1)
d) Reinoculation #1 with test organism
e) Wear cycle with moist cloth (wear #2)
f) Reinoculation #2 with test organism
g) Wear cycle with dry cloth (wear #3)
h) Reinoculation #3 with test organism (end of Day 1)
i) Wear cycle with moist cloth (wear #4)
j) Reinoculation #4 with test organism
k) Wear cycle with a dry cloth (wear #5)
l) Reinoculation #5 with test organism
m) Wear cycle with a moist cloth (wear #6)
n) Sanitizer Test (at least 24 hrs after application of the test product)

Freshly prepared suspension of E. coli was used for the reinoculation at Day 2. After the final inoculation (sanitizer test) followed by 5 minutes of a contact time the test surfaces were transferred to a wide-mouth plastic bottle containing 30 mL of neutralizer broth. The samples were sonicated for 20 seconds in a sonicating water bath followed by agitation on a shaker for 3-4 minutes at 250 rpm. The samples of the negative control were serially diluted in TS broth. All samples were plated within approximately 30 minutes of their transfer to the neutralizer broth. (The control plates had a minimum of 1×10 4 bacteria/carrier for a valid test.) All plates were incubated at 37±2° C. for 48-54 hours. Test

### Samples:

Three formulations with a different concentration of CG-101 were tested for residual self-sanitizing activity. The composition of each formulation is presented in Table 2.

TABLE 2
Composition of CGB-D-100 Tested Disinfectant Formulations.

| Ingredient | Formulation 1 | Formulation 2 | Formulation 3 |
|---|---|---|---|
| CG-101 | 2.00 | 3.00 | 5.00 |
| Alcohol | 60.00 | 60.00 | 60.00 |
| Isopropanol | 5.00 | 5.00 | 5.00 |
| Hydroxypropyl | 0.01 | 0.01 | 0.01 |
| cellulose | | | |
| D-Limonene | 0.40 | 0.40 | 0.40 |
| Water | q.s. | q.s. | q.s. |

The test products neuralization was confirmed for the positive control (Microban® 24) and for the 5% CG-101 disinfectant (the highest concentration of CG-101).

### EXAMPLE 5. EVALUATION OF RESIDUAL SELF-SANITIZING ACTIVITY OF CGB-D-100 ON HARD, NON-POROUS SURFACE

The purpose of this study was to test residual self-sanitizing activity of CGB-D-100 disinfectant per EPA protocol 01-1A, “Residual Self-Sanitizing Activity of Dried Chemical Residues on Hard, Non-Porous Surfaces.”

This study was conducted to test the residual self-sanitizing activity of CGB-D-100 disinfectant containing 2%, 3%, and 5% CG-101, per EPA Protocol #01-1A, and to compare it to the marketed alcohol-based disinfectant Microban® 24 (positive control) that contains a mixture of quaternary ammonium chlorides as an active ingredient. The primary difference between this study and EPA Protocol #01-1A was that wearing cycles were done manually instead of the automated abrasion tester that is listed in the EPA protocol. However, the wearing or wiping effect to be tested as an insult to the surface was similar to that required per the EPA protocol.

The residual self-sanitizing activity was tested by using Escherichia coli (E. coli) as a challenge organism, and by using dry and wet wearing cycles and multiple re-inoculations of the non-porous glass surfaces as described in the protocol. Sterile saline solution was used as the negative control (NC).

Each pre-cleaned glass surface was inoculated with 10 μL of freshly prepared E. coli suspension in concentration of 4.4×10⁶ CFU/mL followed by drying of the bacterial suspension for 30 min at 37° C. After the first inoculation 8 sprays of each test product (˜0.65g) were applied on the glass surface. Then, surfaces were allowed to dry for 3 hrs. After test products and controls were dry on the glass surface the wearing cycle and reinoculations were started.

Six (6) wearing cycles (three dry and three moist) were performed during the 24 hours after the test product and controls (negative control and positive control) application. Wearing cycles were performed manually using the same materials that are described in the EPA 01-1A protocol—a roller with a polyurethane foam, wrapped in a cotton cloth (VWR Cat. # TW-TX 309). Prior to the moist cycle the cloth wipe was wet by using a spray bottle with DI water. The water was sprayed onto the cotton cloth from the distance of 75 cm, and the cotton cloth was used immediately on the glass surface.

Five (5) reinoculations were performed between the wearing cycles. The residual self-sanitizing activity of test products was determined 24 hours after product application. The glass surfaces were inoculated with 10 μL of a fresh E. coli suspension in concentration of 3.3×10⁶ CFU/ml and set aside for a contact time of five (5) minutes. Then, surfaces were transferred to the sterile tubes with 30 mL of neutralization broth. After survived bacteria were suspended in the neutralization broth the samples (0.1 mL) were plated onto Tryptic Soy Agar (TSA) plates. The samples of negative control were serially diluted with TS broth. TSA plates were transferred into the incubator set at 37° C. for 48 h. Bacterial growth was determined after 48 h of incubation.

Neutralization confirmation test was performed in duplicate for Microban® 24 and for 5% CG-101 disinfectant (the highest concentration of CG-101). For the neutralization confirmation, test products as well as negative control (0.9% saline solution) were sprayed (the same exact way as for the residual self-sanitizing study) onto the glass surface, allowed to dry, and then, transferred to the sterile tubes with 30 mL of neutralizer broth. Ten (10) μL of E. coli suspension was added to each solution, sonicated for 20 s and shaken for 3-4 min at 250 rpm. Then, each sample was plated onto the TSA plates and held in an incubator at 37° C. for 48 h.

From FIG. 2 it can be seen that bacterial growth was observed only on the TSA plates where the samples of a negative control were plated. No bacterial growth was obtained for CGB-D-100 samples with 2%, 3%, or 5% of CG-101 as an active ingredient or the positive control. From these results it can be concluded that concentration of 2% CG-101 was sufficient to kill all applied bacteria and to preserve the glass surface for 24 h.

Contamination was observed in the diluted samples of the negative control. Therefore, the survived bacterial counting was performed on the undiluted samples, where much more than 300 CFU per plate were found. The counting of survived organisms should be performed on the plates where no more than 300 colonies are presented, otherwise, the counting is not an accurate and does not reflect the real number of the survived organisms. The obtained results for the undiluted samples of the negative control were 2.3×10⁵ CFU/ml and 1.7×10⁵ CFU/ml for two samples. These results from the negative control validate the test methodology and procedures.

The images in FIG. 3 show that the bacterial growth obtained on the plates where suspension with Microban® 24 and 5% CG-101 disinfectant was plated is similar to that obtained for the saline solution samples. These images confirm that test products and the positive control were successfully neutralized in the neutralization broth.

The residual self-sanitizing activity of CGB-D-100 with 2%, 3%, and 5% CG-101 by weight was confirmed in this study. The data demonstrate that at least 5 log₁₀ reduction was obtained for all concentrations of CG-101 tested as well as the positive control.

The efficacy of CGB-D-100 disinfectant on a non-porous surface was similar to that of the marketed product, Microban® 24, containing 0.276% alkyl dimethyl benzyl ammonium chloride (50% C14, 40% C12, 10%C 16); 0.104% didecyl dimethyl ammonium chloride; 0.207% octyl decyl dimethyl ammonium chloride; 0.104% dioctyl dimethyl ammonium chloride and 68.61% of ethanol.

### EXAMPLE 6. EVALUATION OF ANTIMICROBIAL EFFICACY OF CG-101 IN TIME KILL TESTS

The purpose of this study was to test antimicrobial efficacy of 1%, 3%, and 5% CG-101 disinfectant formulations.

### Study Protocols

The study was performed using the following standard protocols:
I. American Society for Testing and Materials. Standard Test Methods for Evaluation of

Inactivators of Antimicrobial Agents; Designation: E1054-08 (Reapproved 2013). West Conshohocken, PA.
II. American Society for Testing and Materials. Standard Test Method for Assessment of Antimicrobial Activity for Water Miscible Compounds Using a Time-Kill Procedure. Designation: E2783-11 (Reapproved 2016). West Conshohocken, PA.

Initial neutralization testing confirmed that the test material was adequately neutralized at all concentrations tested. The time kill procedure included triplicate testing and all plate counts were performed in duplicate

### Sample Preparation

CG-101 was added to water to form mixtures of 1 wt %, 3 wt %, and 5 wt % of CG-101.

### Results

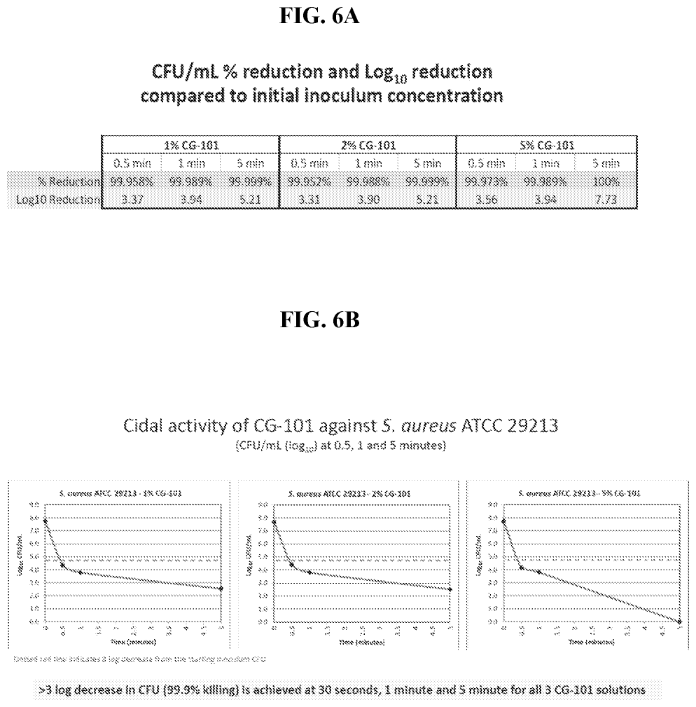

The images in FIGS. 6A and 6B show that >3 log decrease in CFU (99.9% killing) is achieved at seconds, 1 minute and 5 minutes for all 3 CG-101 samples (1%, 3%, and 5%).

### EXAMPLE 7. EVALUATION OF RESIDUAL SELF-SANITIZING ACTIVITY OF SAMPLES CONTAINING CG-101 in WATER AND IN AQUEOUS POLOXAMER SOLUTION

This study was conducted to test the residual self-sanitizing activity of samples containing 5% CG-101 in water, in 5% aqueous Poloxamer 40, and in 10% aqueous Poloxamer 407. Parameters of the experiments are listed below:

### Test Samples and Controls:

Water (Negative Control)
5% CG-101 Aqueous Solution (Positive Control)
5% CG-101 in 5% Poloxamer 407 Aqueous Solution
5% CG-101 in 10% Poloxamer 407 Aqueous solution

### Procedures:

10 μl of E. coli suspension was applied on the surface and dried over 30 min
1 ml of each test sample and control was applied on the surface with a dry inoculum
Contact time of 5 min was used
Neutralization was performed immediately after the contact time
100 μl from each solution was plated onto agar plates and transferred to incubator set at 37 C for 48 hr.
Bacterial growth was observed after 48 hr. In the incubator.

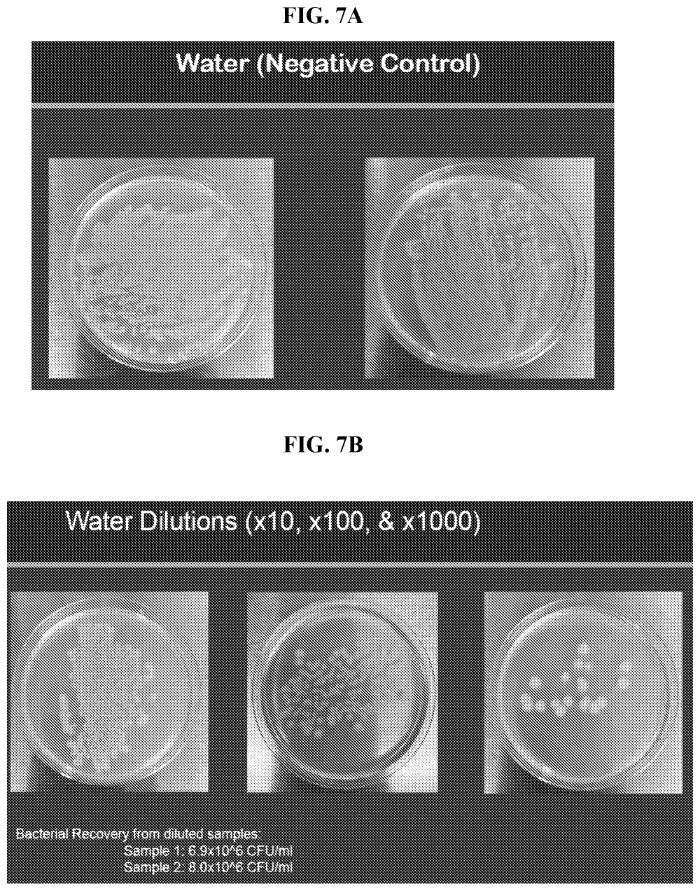

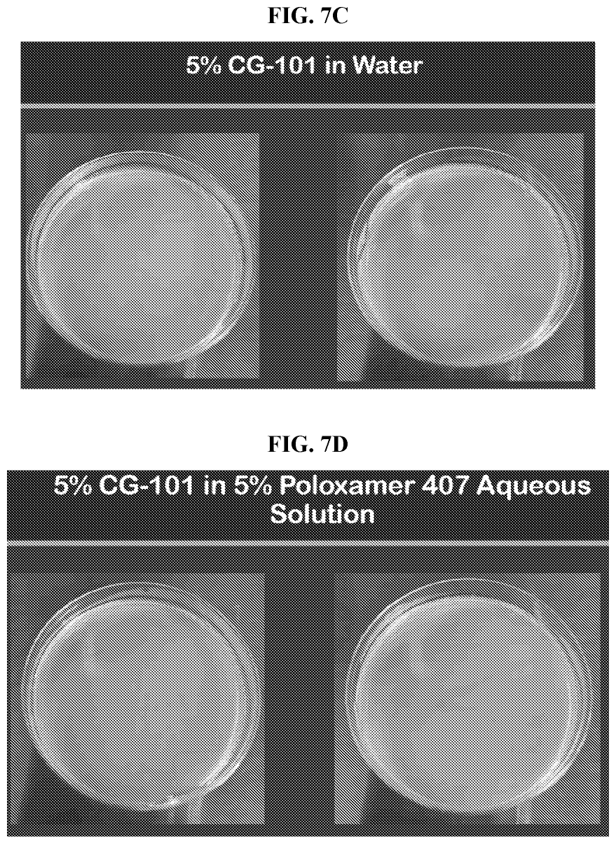

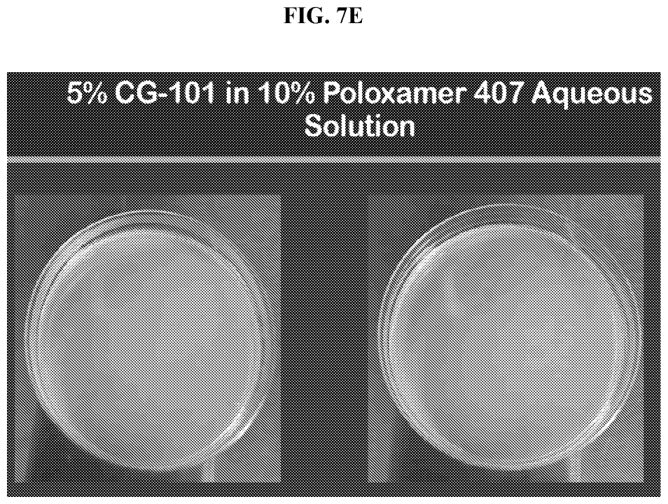

From FIGS. 7A-B it can be seen that bacterial growth was observed only on the TSA plates where the samples of a negative control were plated. No bacterial growth was obtained for samples with 5% of CG-101 in water as the positive control, as shown in FIG. 7C. No bacterial growth was obtained for samples with 5% of CG-101 in 5% aqueous Poloxamer 407 or in 10% aqueous Poloxamer 407, as shown in FIG. 7D and 7E.

Although the disclosure has been described with reference to the above examples, it will be understood that modifications and variations are encompassed within the spirit and scope of the disclosure. Accordingly, the disclosure is limited only by the following claims.

What is claimed is:

1. A disinfectant composition for an inanimate surface, comprising:
an ionic liquid having a cationic component and an anionic component;
wherein the composition comprises about 1% to about 10% by weight of the ionic liquid.

2. The disinfectant composition of claim 1, wherein the anionic component is bistriflimide, a geranate, an oleate, a hexanoate, dodecyldimethyl ammonia propane sulfonate, N-lauryl sarcosinate, or a geraniolate.

3. The disinfectant composition of claim 2, wherein the cationic component is benzyl pyridinium, benzyl dimethyl dodecyl ammonium, a choline cation, phosphonium, benzethonium, or a phosphonium.

4. The disinfectant composition of claim 1, wherein the cationic component is a choline cation.

5. The disinfectant composition of claim 4, wherein the anionic component is a geranate anion.

6. The disinfectant composition of claim 5, wherein the cationic component and the anionic component are in a molar ratio ranging from about 1:1 to about 1:2 (cationic component to anionic component).

7. The disinfectant composition of claim 5, wherein the cationic component and the anionic component are in a molar ratio of about 1:2 (cationic component to anionic component).

8. The disinfectant composition of claim 5, wherein the composition comprises about 1% to about 5% by weight of the ionic liquid.

9. The disinfectant composition of claim 5, wherein the composition comprises about 1% to about 3% by weight of the ionic liquid.

10. The disinfectant composition of claim 5, wherein the composition comprises about 2% of the ionic liquid.

11. The disinfectant composition of claim 8, wherein the composition further comprises ethanol, iso-propyl alcohol, or a combination thereof.

12. The disinfectant composition of claim 8, wherein the composition further comprises from about 50% to about 70% by weight of ethanol.

13. The disinfectant composition of claim 8, wherein the composition further comprises from about 2% to about 10% by weight of a poloxamer.

14. The disinfectant composition of claim 8, wherein the composition further comprises from about 3% to about 10% by weight of Poloxamer 407.

15. The disinfectant composition of claim 8, wherein the composition further comprises from about 5% to about 10% by weight of Poloxamer 407.

16. The disinfectant composition of claim 15, wherein the composition further comprises from about to about 1.0% by weight of D-limonene.

17. The disinfectant composition of claim 15, wherein the composition further comprises from about to about 0.6% by weight of D-limonene.

18. The disinfectant composition of claim 15, wherein the composition further comprises from about to about 0.4% by weight of hydroxypropyl cellulose.

19. The disinfectant composition of any one of claims 15, wherein the composition further comprises from about 0.005% to about 0.02% by weight of hydroxypropyl cellulose.

20. The disinfectant composition of claim 15, wherein the composition further comprises water.

21. The disinfectant composition of claim 20, the composition is placed on or in an applicator or dispenser.

22. A method of sanitizing or disinfecting a surface, comprising applying to the surface the composition of claim 20.

23. A method for inhibiting or decreasing microbial growth on a surface, comprising applying to the surface the composition of claim 20.

24. The method of claim 23, wherein the microbial growth is growth of a virus, bacterium, fungus, mold, protozoan, parasite, or combinations thereof.

25. The method of claim 24, wherein the bacterium is a gram-negative bacterium.

26. The method of claim 25, wherein the gram-negative bacterium is an Escherichia, Salmonella, Klebsiella bacterium, or any combination thereof.

27. The method of claim 67, wherein the bacterium is a gram-positive bacterium.

28. The method of claim 71, wherein the gram-positive bacterium is a Staphylococcus or Streptococcus bacterium.

29. The method of claim any one of claims 66-73, wherein the virus is an Ebolavirus, Coronavirus, Rotavirus, Alphainfluenzavirus, Betainfluenzavirus, Deltainfluenzavirus, Gammainfluenzavirus, or any combination thereof.

30. The method of claim 29, wherein the Coronavirus is severe acute respiratory syndrome coronavirus 2 (SARS-CoV-2).
